(19) United States
(12) Patent Application Publication
(10) Pub. No.: US 2016/0037432 A1
(43) Pub. Date: Feb. 4, 2016

(54) ENHANCED COMMON LOGICAL-A PROTOCOL FOR RECONFIGURABLE SYSTEMS

(71) Applicant: INTERDIGITAL PATENT HOLDINGS, INC., Wilmington, DE (US)

(72) Inventors: Zinan Lin, Basking Ridge, NJ (US); Amith V. Chincholi, Sunnyvale, CA (US); Chunxuan Ye, San Diego, CA (US); Alpaslan Demir, East Meadow, NY (US); Tan B. Le, New York, NY (US)

(73) Assignee: INTERDIGITAL PATENT HOLDINGS, INC., Wilmington, DE (US)

(21) Appl. No.: 14/774,701

(22) PCT Filed: Mar. 13, 2014
(86) PCT No.: PCT/US14/25727

§ 371 Date: Sep. 10, 2015

Related U.S. Application Data
(60) Provisional application No. 61/788,401, filed on Mar. 15, 2013.

(51) Int. Cl. H04W 40/24; H04W 12/06; H04W 8/00

(52) U.S. Cl. CPC H04W 40/244; H04W 8/005; H04W 12/06; H04W 88/08

(57) ABSTRACT

A network has a central entity connected to a plurality of capillary networks and external networks. Information regarding the capillary networks and the external networks may be fused in the central entity to provide assistance services and network control to one or more of the capillary networks. The information may be collected from the capillary networks using a logical interface with a common upper layer coupled to multiple Radio Access Technologies (RATs). The central entity configures an internal communications network including a plurality of disparate devices, and recognizes and communicates with each device within the internal communications network by discovering each new device as introduced into the internal communications network. A communication link can be set up with reconfigurable or capable devices to exchange information possibly in another format in another band. The same communication link can be torn down after completion of the service.

### CROSS REFERENCE TO RELATED APPLICATIONS

This application claims the benefit of U.S. Provisional Patent Application No. 61/788,401, filed Mar. 15, 2013, the content of which is hereby incorporated by reference herein.

### BACKGROUND

In recent years, wireless technologies have been demanding higher data rates and lower latencies. The use of carrier aggregation and multi-RAT capabilities has been introduced. The use of multi-RAT, e.g., RAT aggregation, may allow reception and/or transmission over multiple RATs, e.g., simultaneously, such as LTE with WCDMA, LTE with WiFi, etc. Moreover, modern wireless networks may be heterogeneous in nature in that they support more than one radio access technology (RAT), for example, LTE, HSPA, Wi-Fi, Zigbee, Bluetooth, etc.

With the advent of small cells, the access point (AP)/base station (BS) or other central entity of each small cell may be expected to support multiple RATs simultaneously, some of which may be for broadband communication with high data rate requirement while others may be for machine-type (M2M) communication with low data rate requirement. New RATs could be developed at different times by different parties. Incompatibility between legacy-RAT-based access points and new-RAT-based end-user devices may be apparent.

For example, in the case of M2M communication, multiple standards with different PHY/MAC designs are being developed either based on legacy standards. When consumers buy electronic devices with wireless capabilities, each of which supports at least one of these RATs (legacy and/or new), the access point/base station may not always be upgraded to support new/enhanced RATs, thus making it difficult or impossible for a legacy AP/BS and the new end-user device to communicate with each other.

### SUMMARY

A network may comprise a central base station coupled to an external communications network. The base station configures an internal communications network including a plurality of disparate devices, and recognizes and communicates with each device within the internal communications network by discovering each new devices as introduced into the internal communications network, either by obtaining protocols for each new device from a local database or from a remote database if not available at the local database. A communication link can be set up with reconfigurable or capable devices in order to exchange information possibly in another format in another band. The same communication link can be torn down after completion of the service.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 1D is a system diagram of an another example radio access network and another example core network that may be used within the communications system illustrated in FIG. 1A;

FIG. 1E is a system diagram of an another example radio access network and another example core network that may be used within the communications system illustrated in FIG. 1A;

FIG. 2 is a system diagram of a central entity (for example, a CRG) connected to a plurality of capillary networks and external networks;

FIG. 3 is a system diagram of a central entity connected to a plurality of reconfigurable networks and external networks;

FIG. 4 is a diagram of a Centralized Reconfigurable Gateway (CRG);

FIG. 5 is a diagram of a Reduced Reconfigurable Gateway (RRG);

FIG. 6 is a diagram of a Reduced Reconfigurable Gateway (RRG);

FIG. 7 is a flow chart of actions taken by a CRG;

FIG. 8 is a diagram of Reconfigurable Platform (RP) for an RRG which supports one RAT at one time;

FIG. 9 is a diagram of multiple RPs for an RRG which supports multiple RATs at one time;

FIG. 10 is a diagram of legacy devices and RRGs associating with a CRG via a common control channel (CCC);

FIG. 11 is a diagram of a call flow for authentication and association with a CRG via passive scanning;

FIG. 12 is a diagram of a call flow for authentication and association with a CRG via active scanning;

FIG. 13 is a diagram of a new CRG powering up, discovering neighbors, and forming a reconfigurable network;

FIG. 14 is a diagram of a call flow for reconfigurable network formation;

FIG. 15 is a diagram for a reconfigurable wireless network control signaling and data transmission;

FIG. 16 is a diagram of data communication within the reconfigurable wireless network;

FIGS. 17-21 are diagrams of call flows which depict initial link setups and teardowns to various devices within a reconfigurable wireless network;

FIG. 22 is a diagram of a CRG guiding an associated Type I RRG to switch RATs;

FIGS. 23-28 are diagrams where data links and the CCC share multiple channels for various devices within a reconfigurable wireless network;

FIG. 29 is a diagram of usage of reconfigurable gateways in shared spectrum.

### DETAILED DESCRIPTION

A detailed description of illustrative embodiments will now be described with reference to the various drawing Figures. Although this description provides a detailed example of possible implementations, it should be noted that the details are intended to be exemplary and in no way limit the scope of the application.

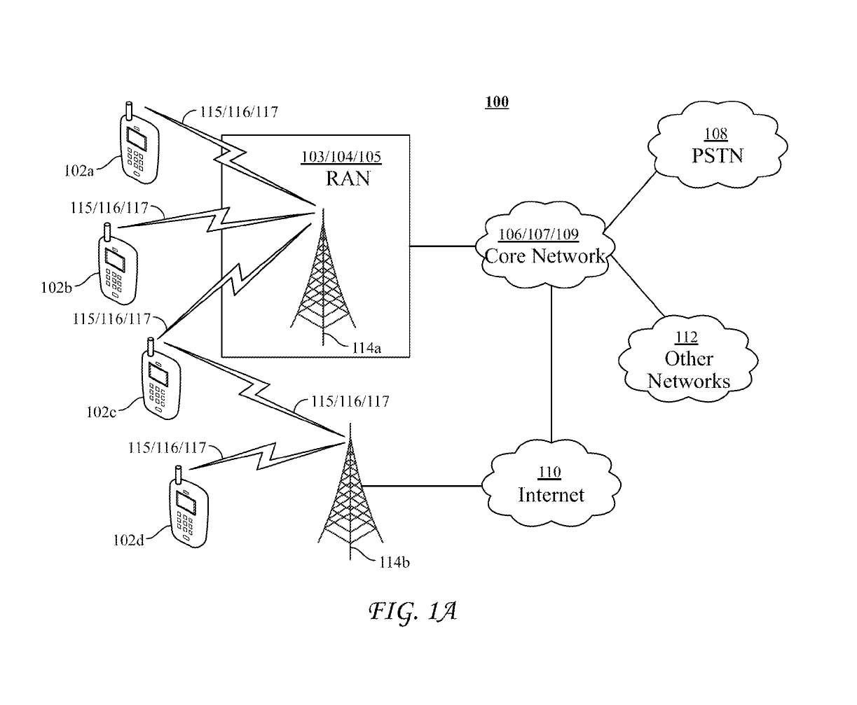

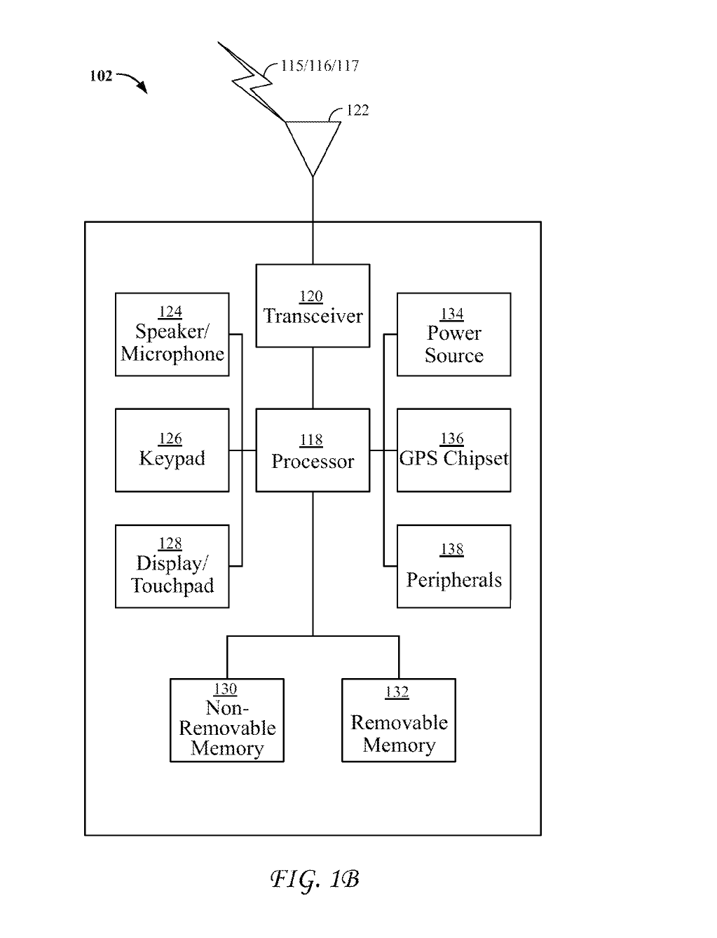

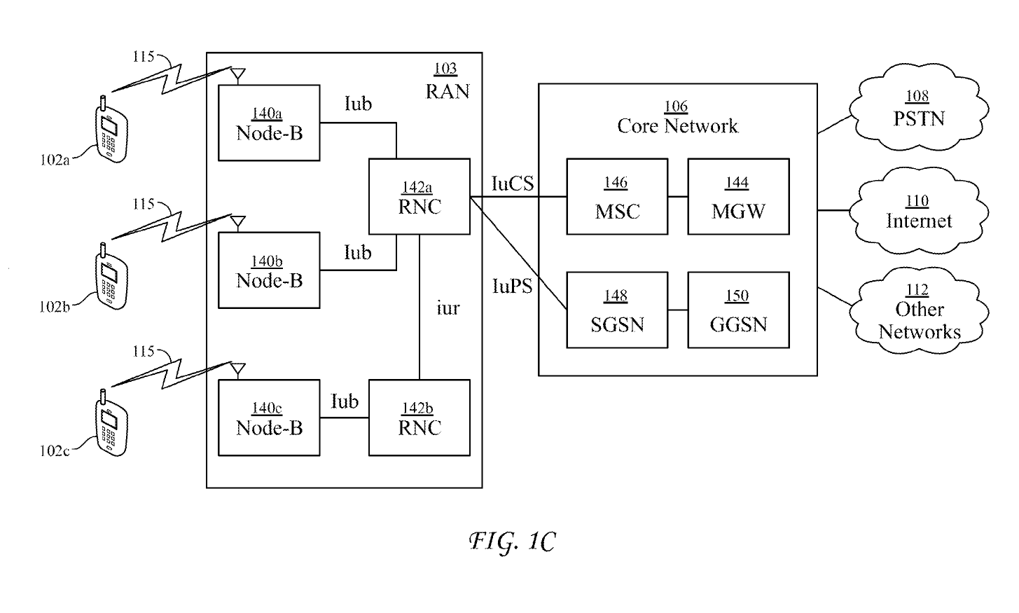

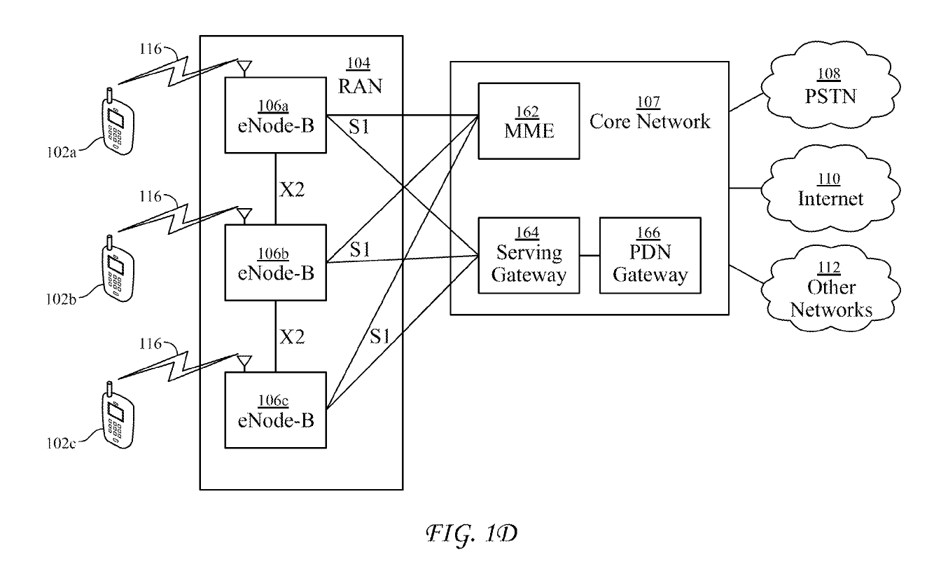

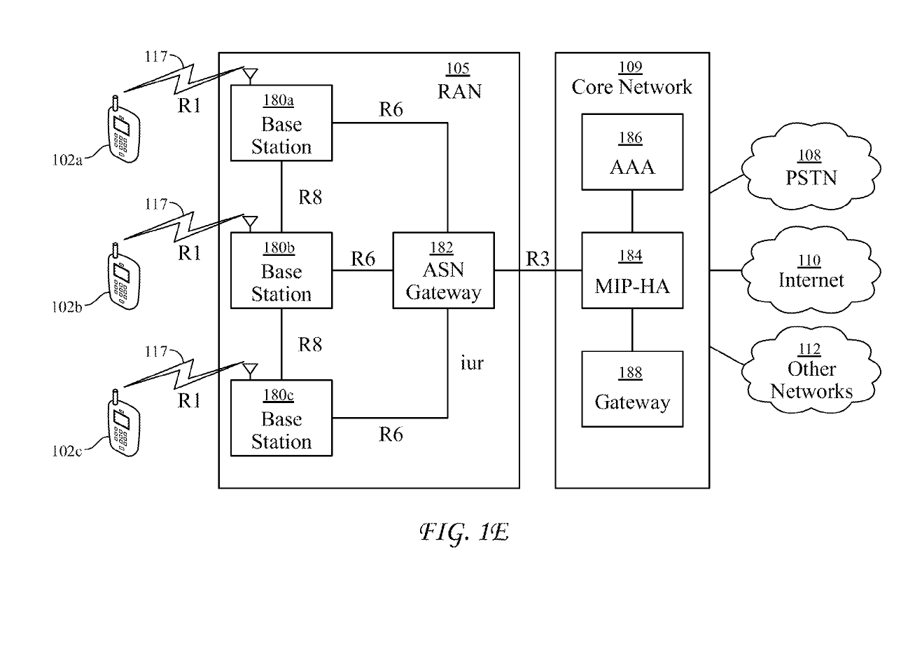

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, and/or 102d (which generally or collectively may be referred to as WTRU 102), a radio access network (RAN) 103/104/105, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 IX. CDMA2000 EV-DO, Interim Standard 2000 (IS-2000), Interim Standard 95 (IS-95). Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B. Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication. Although not shown in FIG. 1A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 or a different RAT.

Some or all of the WTRUs 102a. 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 1B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth, module, a frequency modulated (FM) radio unit, a digital music player, a media player, a video game player module, an Internet browser, and the like.

FIG. 1C is a system diagram of the RAN 103 and the core network 106 according to an embodiment. As noted above, the RAN 103 may employ a UTRA radio technology to communicate with the WTRUs 102a, 102b, 102c over the air interface 115. The RAN 103 may also be in communication with the core network 106. As shown in FIG. 1C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an lub interface. The RNCs 142a, 142b may be in communication with one another via an lur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 1D is a system diagram of the RAN 104 and the core network 107 according to an embodiment. As noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b. 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 1D, the eNode-Bs 160a, 160b, 160c may communicate with one another over an X2 interface.

The core network 107 shown in FIG. 1D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a. 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b. 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a. 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 1E is a system diagram of the RAN 105 and the core network 109 according to an embodiment. The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 1E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell (not shown) in the RAN 105 and may each include one or more transceivers for communicating with the WTRUs 102a, 102b, 102c over the air interface 117. In one embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 1E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 1E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

In view of a communications system such as the example communications system 100 set forth in connection with FIGS. 1A-1E, it is to be appreciated that radio communications systems are becoming heterogeneous such that multiple RATs may be available at the same time at any terminal.

Thus, the cognitive capabilities of the terminals become an important aspect to address so as to enable optimization of the radio usage. A Cognitive Pilot Channel (CPC) enables collaboration between a network and the terminals thereof. Each terminal may use CPC either in the “start-up” phase i.e. when the terminal is powered on, or, in the “ongoing” phase i.e. when the terminal is registered-to/camped-on a network. The CPC may deliver information on frequency bands allowed/available for secondary access in a geographic region. Using CPC may reduce the time it takes to sense the spectrum and may ensure that secondary systems adhere to the regulatory framework.

An out-band CPC may be a radio channel outside the component Radio Access Technologies. In the out-band CPC, the CPC may use a radio interface, and/or may use an adaptation of legacy technology with appropriate characteristics. An in-band CPC may convey information using a transmission mechanism (e.g., a logical channel) in the same radio access technologies that are used for the user data transmission, and may be allowed to bear information to both uplink and downlink.

Some of the functionalities and features of the CPC may include: helping the mobile terminal select the proper network based on conditions; providing means for sensing information exchange during spectrum sensing; and assisting in secondary system start-up, etc. A CPC procedure may be provided on the terminal side, which combines the usage of out-band and in-band CPC. CPC may be operated in a start-up phase when the terminal is switched on, where the terminal starts listening to the out-band CPC in order to obtain basic parameters (e.g., available networks at that location), may select and connect to a network. CPC may be operated in an ongoing phase where, once the terminal is connected to a network, such terminal stops listening to the out-band CPC and starts receiving the in-band CPC within the registered network.

The End-to-End Reconfigurability (E2R) project (also known as the E2R project), has developed concepts and solutions for a cognitive pilot channel (CPC) encompassing both in-band/out-band and uplink/downlink functionalities in the context of multi-RAT heterogeneous networks. The CPC may be expected to broadcast relevant information regarding frequencies, RATs, load situation, etc. based on the time, situation, and location of a corresponding terminal. Radio environment discovery mechanisms are provided regarding minimum system information needed by a terminal to select a network and frequency at power-on. Also, an operator level (level 2) CPC may be provided to help an operator to rank available RATs to be used/camped-on so that if a terminal camps on a heavily loaded network, the operator can delete the RAT information using the CPC.

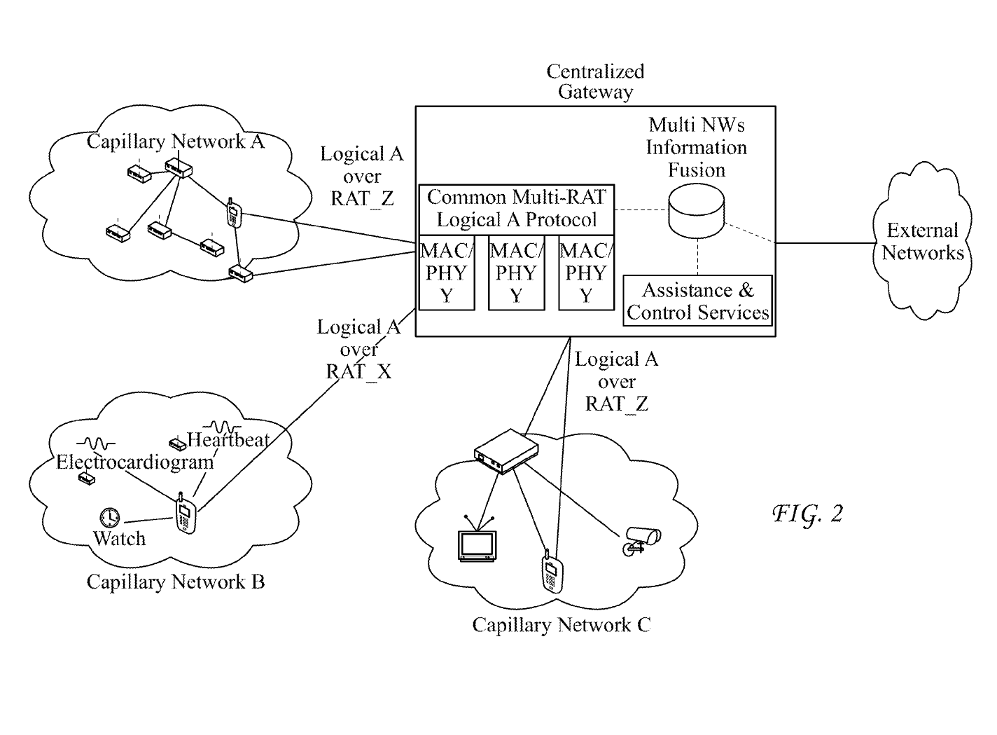

Turning now to FIG. 2, a central entity (Gateway, or CRG) may be connected to a plurality of capillary networks (e.g., internal networks) and external networks. Information of the capillary networks and the external networks may be fused in the central entity to provide assistance services and network control to one or more of the capillary networks, as well as to control one or more of the capillary networks in assisting another capillary network. As will be set forth in more detail below, the information from a plurality of capillary networks can be collected using a logical interface with a common upper layer coupled to multiple Radio Access Technologies (RATs), where the common upper layer may be used to communicate with the plurality of capillary networks.

The logical interface provides signaling support for a set of control procedures that may be managed by a “Common Logical A protocol” (FIG. 2). The CRG collects information from the capillary networks and the external networks and fuses this information to provide assistance services and network control to each of the capillary networks, as well as control to each of the capillary networks in assisting another capillary network.

The system architecture may include several devices and networks that use different RATs. RAT-agnostic utilization of devices maybe enabled by leveraging policy based re-configurability in order to reduce hardware size, simplify power management complexity and increase compatibility among legacy or new RATs. A reconfigurable access point/base station or central entity may address the incompatibility issue between legacy-RAT-based access points and new-RAT-based end-user devices. Reconfiguration on-the-fly to support the missing RAT may include missing RAT discovery, and the capability to download and install the instruction set of a discovered missing RAT. Procedures to enable missing RAT discovery and missing RAT instruction set download and installation may be provided, as will be discussed.

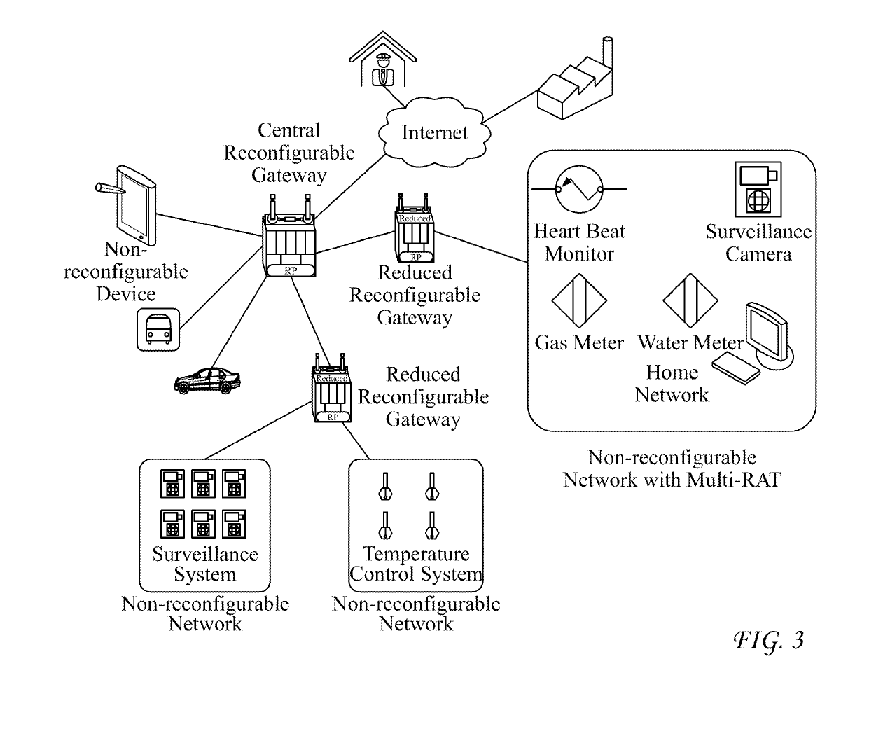

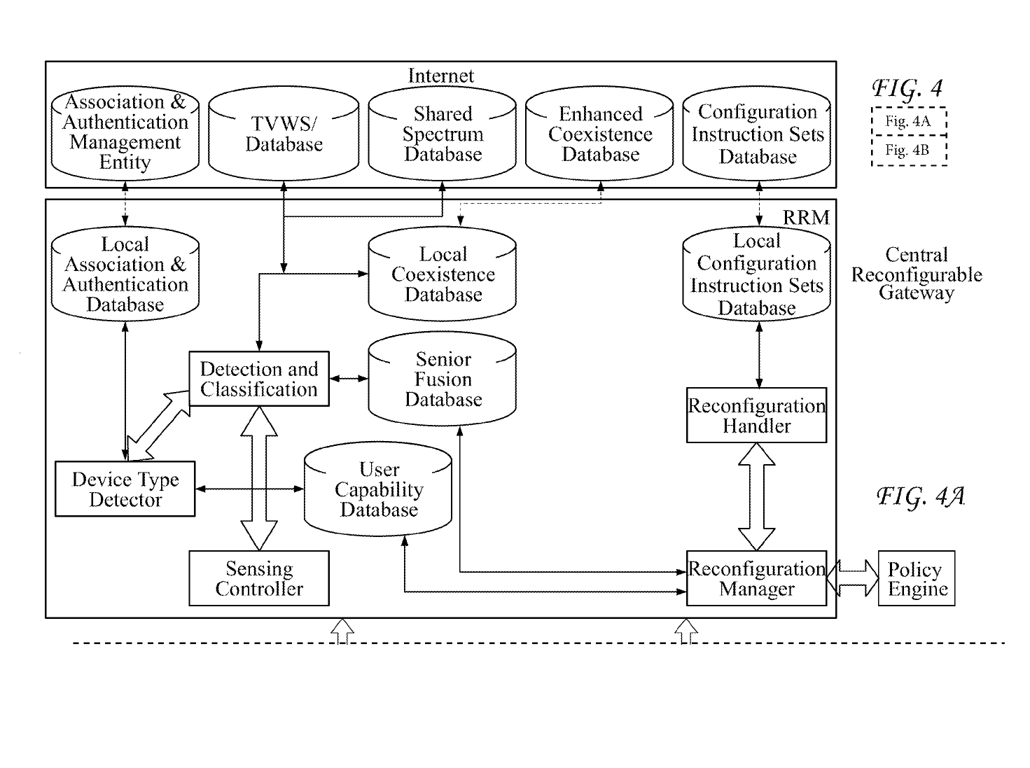

FIG. 3 shows an example deployment of a reconfigurable network. The system may support multiple types of devices such as a Central Reconfigurable Gateway (CRG), a Reduced Reconfigurable Gateway (RRG), non-reconfigurable device, and/or the like.

The CRG may include a gateway with a direct connection to the public/private IP network. The CRG may include reconfigurable software and hardware entities, support simultaneous multi-RAT operation, and provide RAT configuration guidance for reconfigurable slave devices. The CRG may transmit beacons on a common control channel (CCC).

The RRG may include a gateway with no direct connection to the public/private IP network. The RRG may include reconfigurable software and hardware entities, and may support multi-RAT operation (in some instances, simultaneous multi-RAT operation). In a Type 1 device, simultaneous multi-RAT operation may be supported. In a Type 2 device, simultaneous multi-RAT operation may not be supported. One RAT may be selected in a Type 2 device, and switching of RATs may be supported. The RAT used by the RRG may be configured by a reconfigurable master device (e.g., CRG).

A non-reconfigurable device may be included in the network. Such a device has no reconfiguration capabilities and may be a legacy device supporting one or more RATs.

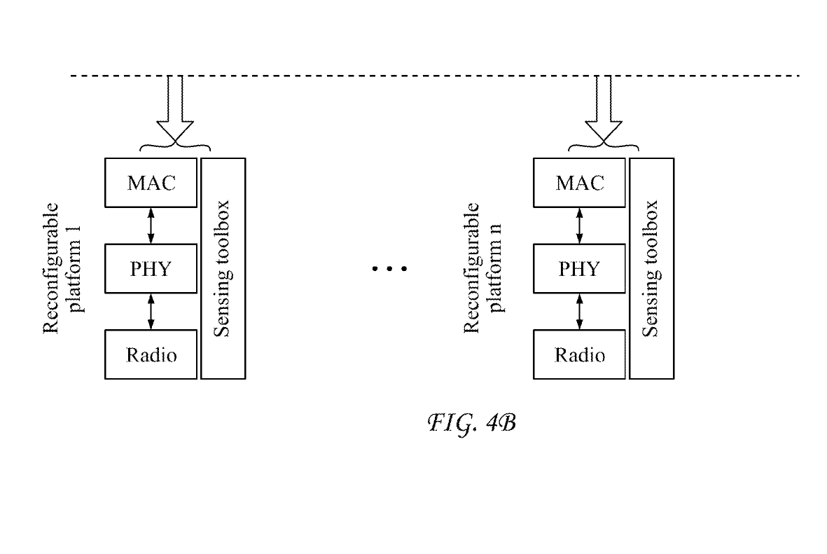

Turning now to FIG. 4, the architecture for the Centralized Reconfigurable Gateway (CRG) is shown. A reconfiguration manager may receive the data transmission request from its slave devices (e.g., RRG or legacy devices) or from an upper layer (e.g., via Internet). The reconfiguration manager may collect necessary information for data link setup, such as user capabilities, spectrum availabilities and restrictions, communication link situations and policy restrictions, etc. The reconfiguration manager may determine data link details such as band and channel, RAT, transmission limitations, maximum Tx power, antenna gain, spectrum mask, power saving modes, starting time and ending time, etc. The reconfiguration manager may deliver data link decisions to the reconfiguration handler and slave devices. Some instruction sets might also be sent by the reconfiguration manager to a reconfigurable slave device (e.g., RRG).

A reconfiguration handler may receive a reconfiguration request from the reconfiguration manager. In response, such handler may collect the necessary instructions from instruction databases and may also send some instruction sets to the reconfiguration manager. The handler may handle the reconfiguration of MAC, PHY and RF.

A device type detector may be used in the CRG to detect and classify user devices. The detector may manage a user association and authentication procedure via an association and authentication database, and also maintains the user capability database.

A detection and classification entity may maintain a spectrum availability database. Such entity may connect to a TVWS database and/or coexistence database and request a sensing controller for spectrum sensing operation.

A sensing controller may control the sensing toolbox for spectrum sensing operations. The controller may schedule the silent period and provide spectrum sensing results to a spectrum manager.

A policy engine may control spectrum usage based on regulations, operator/user preferences, etc.

A sensing toolbox may perform spectrum sensing operations under the control of the sensing controller.

A user capability database may maintain User ID, RF capabilities, supported MAC protocols, supported PHY processors, carrier aggregation capabilities, etc.

Other entities of the CRG are contemplated. A sensor fusion database may maintain location, band, channel, interference level, available duration, transmission power limitation, antenna limitation, etc. A local configuration instruction set database may maintain separate instructions to reconfigure MAC protocols and PHY processors. A local coexistence database may maintain spectrum usage information of neighbor networks. The neighbor networks may be synchronized with a network enhanced coexistence database. A local association and authentication database may maintain the Local association and authentication information and may be synchronized with a network association and authentication management entity. One or more reconfigurable platforms may be used to implement protocol stacks (MAC, PHY, RF) for data links and common control channels. A network enhanced coexistence database may maintain location-based RAT/spectrum information. A network association and authentication management entity may maintain application-dependent device membership verification. A network instruction set database may maintain instruction sets for different RATs.

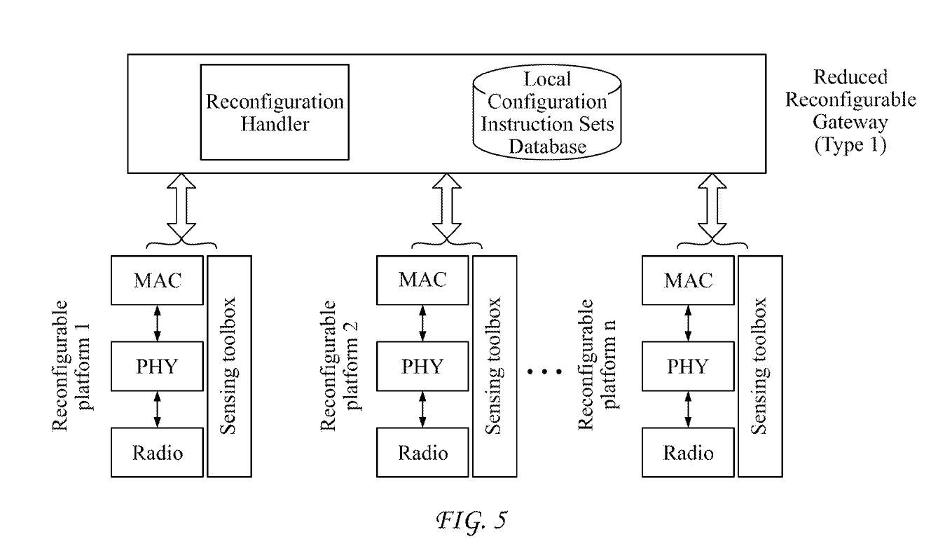

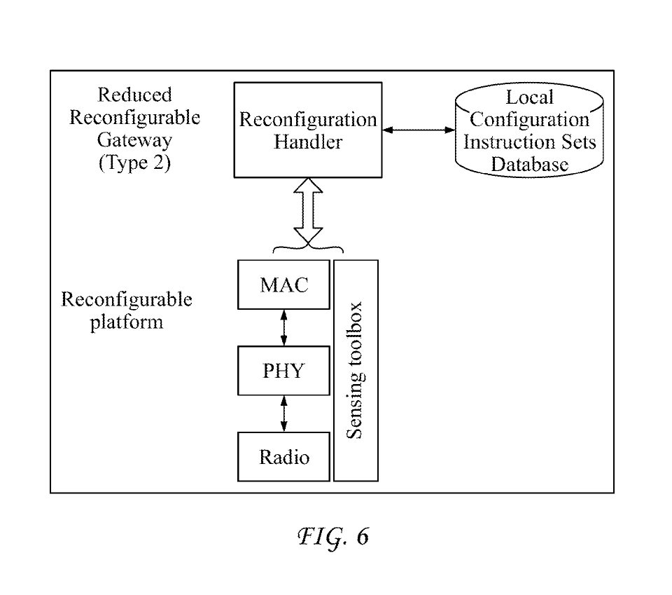

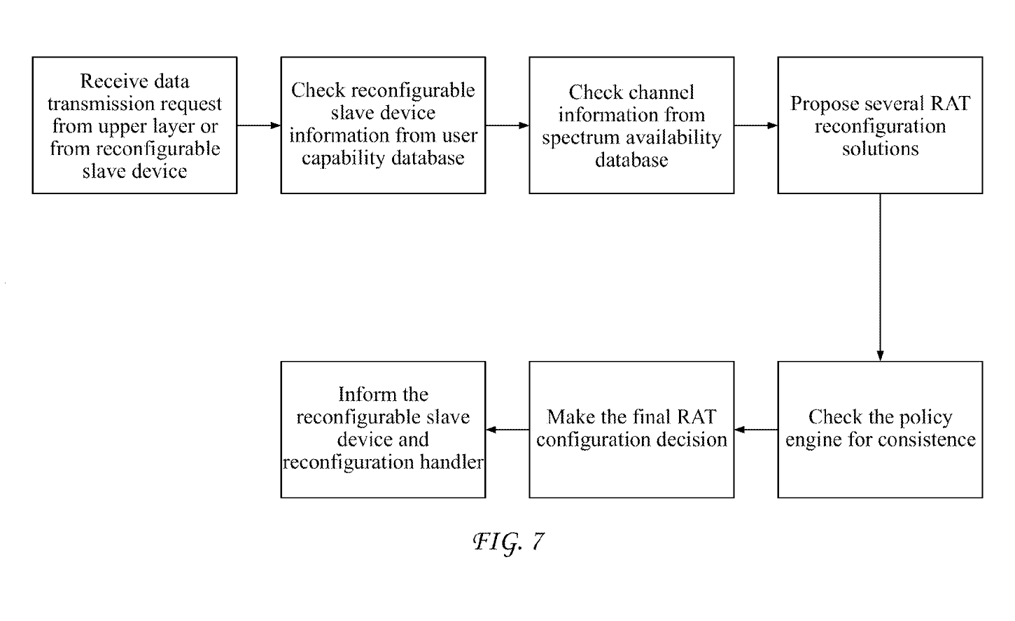

Turning now to FIGS. 5 and 6, the architectures for the Reduced Reconfigurable Gateway (Type I, FIG. 5 and Type II, FIG. 6) are shown. In the Type I architecture (FIG. 5), a reconfiguration handler may receive a reconfiguration request and some instruction sets from the CRG, collect the necessary instructions from a database, and handle the reconfiguration of MAC, PHY and RF. A local configuration instruction set database may maintain separate instructions to reconfigure MAC protocols and PHY processors. One or more reconfigurable platforms may be used to implement protocol stacks (MAC, PHY, RF) for data links and common control channels.

In the Reduced Reconfigurable Gateway Type II architecture in FIG. 6, the same elements as the Type I architecture may appear, although only a single reconfigurable platform may be used to implement a protocol stack (MAC, PHY, RF) for either a common control channel or a data link.

Turning to FIG. 7, the CRG (for example, the reconfiguration manager) takes certain actions regarding data transmission requests.

When a data transmission procedure is network-initiated, the network application may send a data request to the central reconfigurable gateway (CRG), the CRG may decide which band/channel/RAT to use for the transmission, based on user capabilities, spectrum availabilities, data categories, etc., the CRG may send a configuration for the opted band/channel/RAT configuration to the RRG via a common control channel (CCC), and both the CRG and RRG may set their reconfigurable platforms accordingly. A data link may be set up between the reconfigurable platforms of the CRG and RRG, data transmission may occur, and the data link may be subsequently torn down.

When a data transmission procedure is initiated by an end device, the RRG may send a data request to CRG via a common control channel; the CRG may decide which band/channel/RAT to use for the transmission, based on user capabilities, spectrum availabilities, data categories, etc., the CRG may send configuration for the opted band/channel/RAT to RRG via a common control channel, and both the CRG and RRG may set their reconfigurable platforms accordingly. A data link may be set up between the reconfigurable platforms of the CRG and RRG, data transmissions may occur, and the data link may be subsequently torn down.

Different types of devices may exist in the reconfigurable networks and the available RATs in the network may be changed with multiple factors, e.g., device capabilities, QoS requirement, traffic load, etc. To support the efficient operation of the reconfigurable network with different types of devices and variable RATs, a unified control protocol may be provided to connect the devices, e.g., CRG, RRGs and legacy devices. In particular, a common control channel (CCC) may be provided between the CRG and the associated RRGs and legacy devices (or between the RRG and the associated devices). The CCC may provide functionalities including: transmission of beacon and paging information, which may include multiple system information, e.g., available bands, operational bandwidth, operational RATs, etc.; enabling data link set-up and tear down; synchronization among devices; detection and notification of surrounding RATs between CRG/RRG and legacy devices; downloading and transmission of instruction sets needed for different RATs; monitoring and transmission requests from RRGs and legacy devices; and/or providing device association and authentication information; among other things.

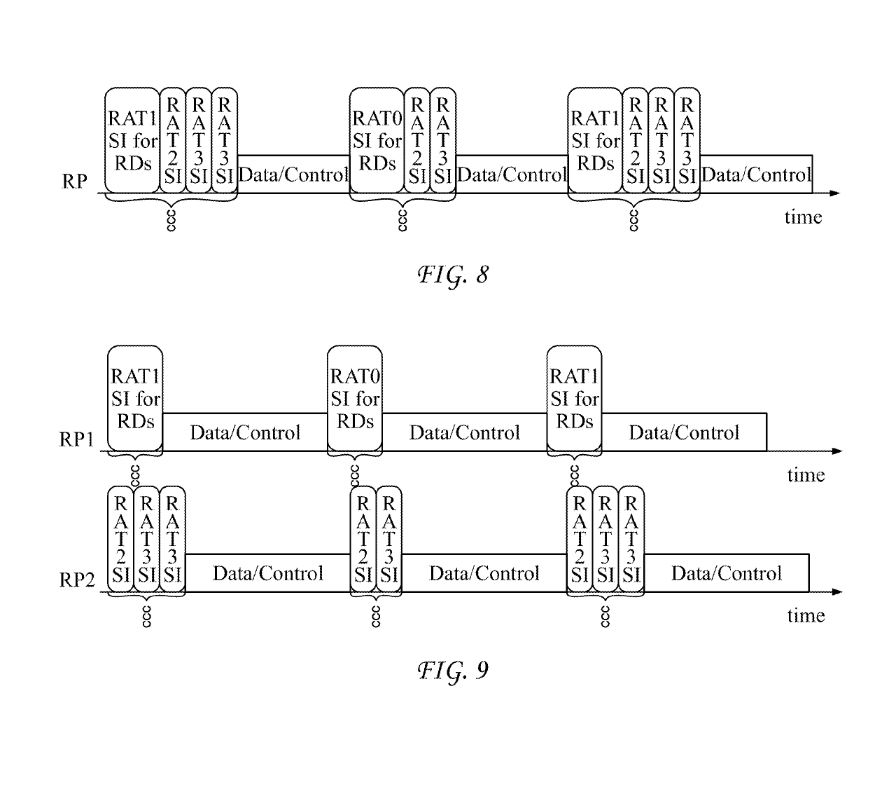

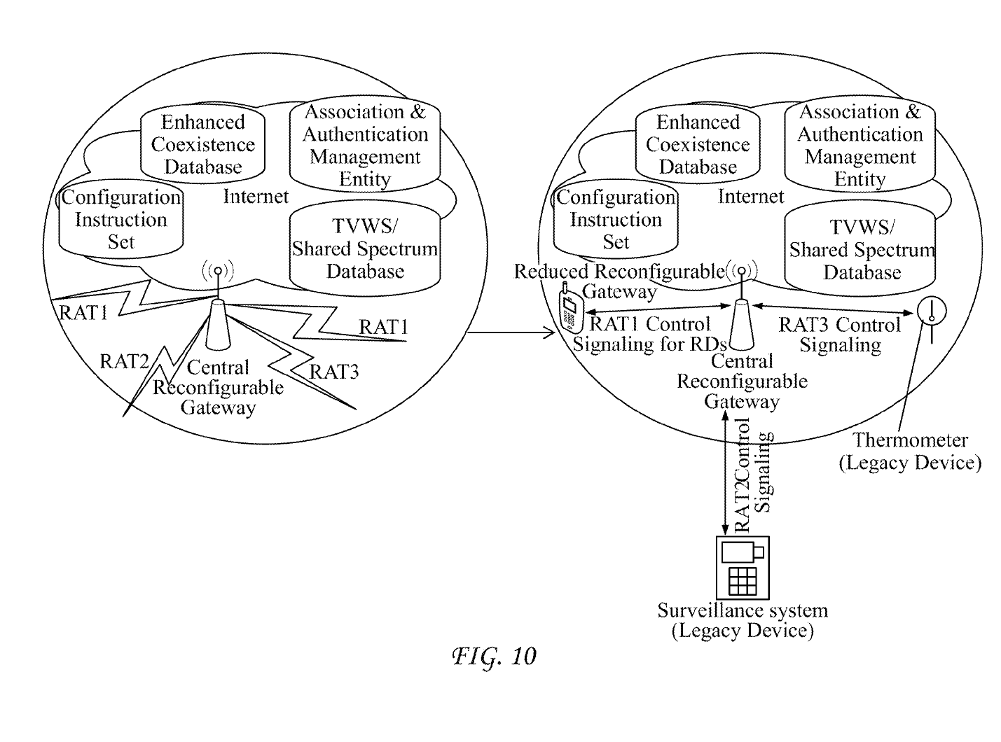

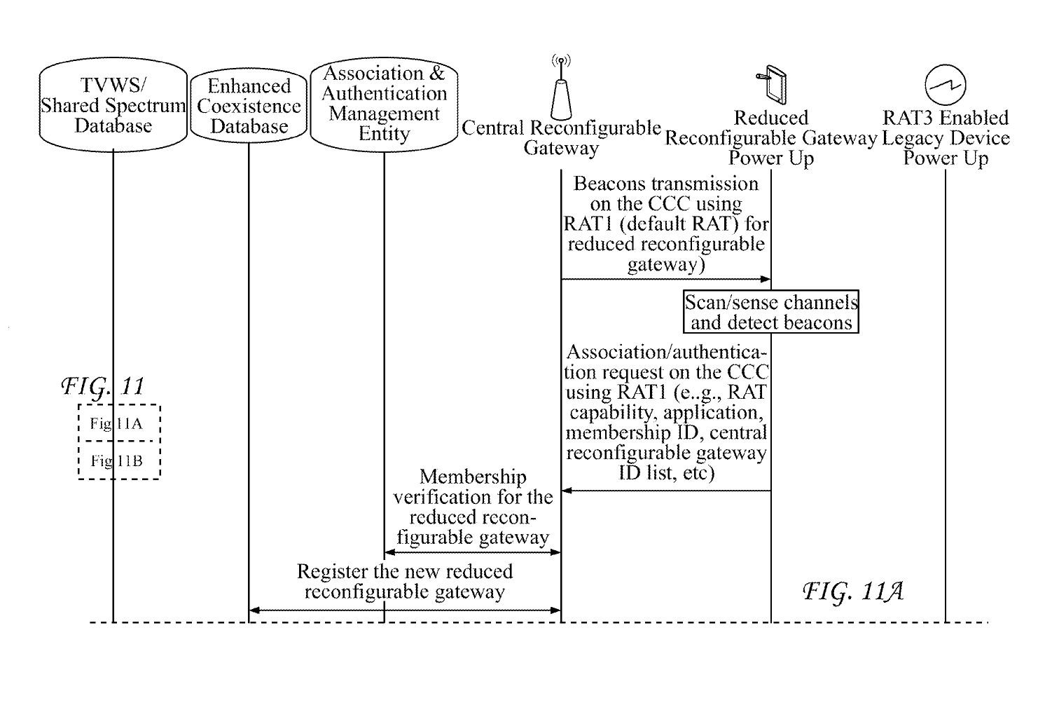

Turning to FIGS. 8 &9, reconfigurable gateways can adapt the CCC to any RAT according to different criteria such as environment (channel conditions), available frequencies, end device types, etc. The reconfigurable gateway may alternatively or additionally activate available RATs in different ways. For example, for the reconfigurable gateway with a single Reconfigurable Platform (RP) which supports one RAT at one time (FIG. 8), such gateway can run the CCC with different RATs at different times. For a reconfigurable gateway with multiple reconfigurable platforms supporting multiple RATs simultaneously (FIG. 9), such gateway can run the CCC with different RATs in different bands.

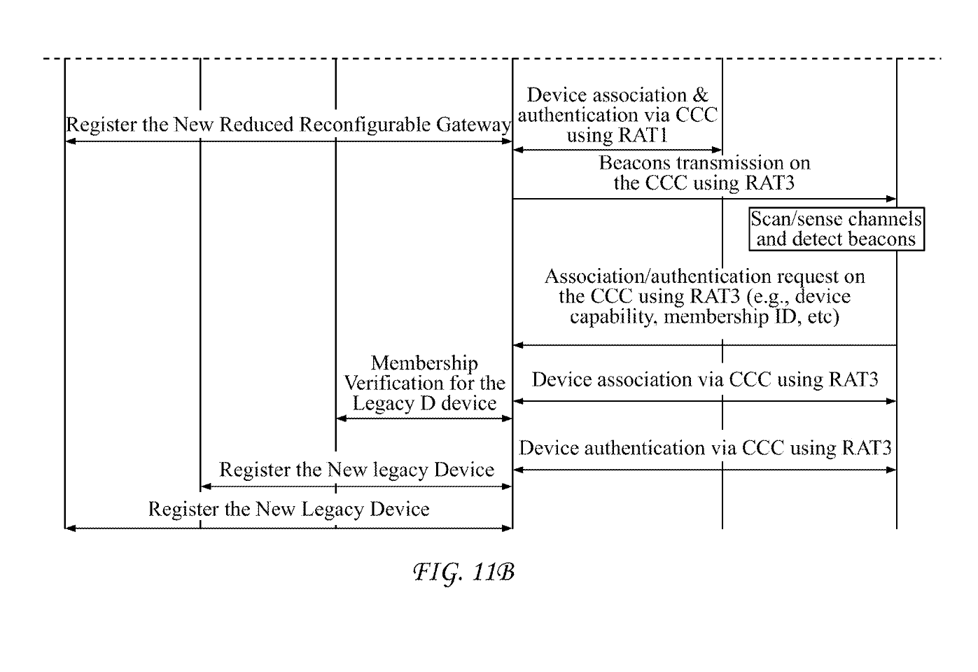

Turning to FIG. 10, device discovery may be performed in a reconfigurable network. This includes how devices can associate with the CRG when the CRG exists and how the CRG can form a reconfigurable network after CRG powers up. Initially (the left portion of FIG. 10), a CRG may exist with or without associated RRGs and legacy devices. RRGs or legacy devices thus move into the network covered by the CRG and such devices perform association with the CRG (the right portion of FIG. 10). In particular, and referring now to FIG. 10, RRGs associate with the CRGs via CCC, while legacy devices may associate with the CRG via CCC using legacy protocols.

Turning to FIG. 1, a call flow for authentication and association via passive scanning is shown. The CRG may transmit beacons on the CCC using RAT1, which may be the default RAT for RRG. The CRG may alternatively or additionally activate RAT3 to transmit beacons on CCC and associate with RAT3-enabled legacy devices.

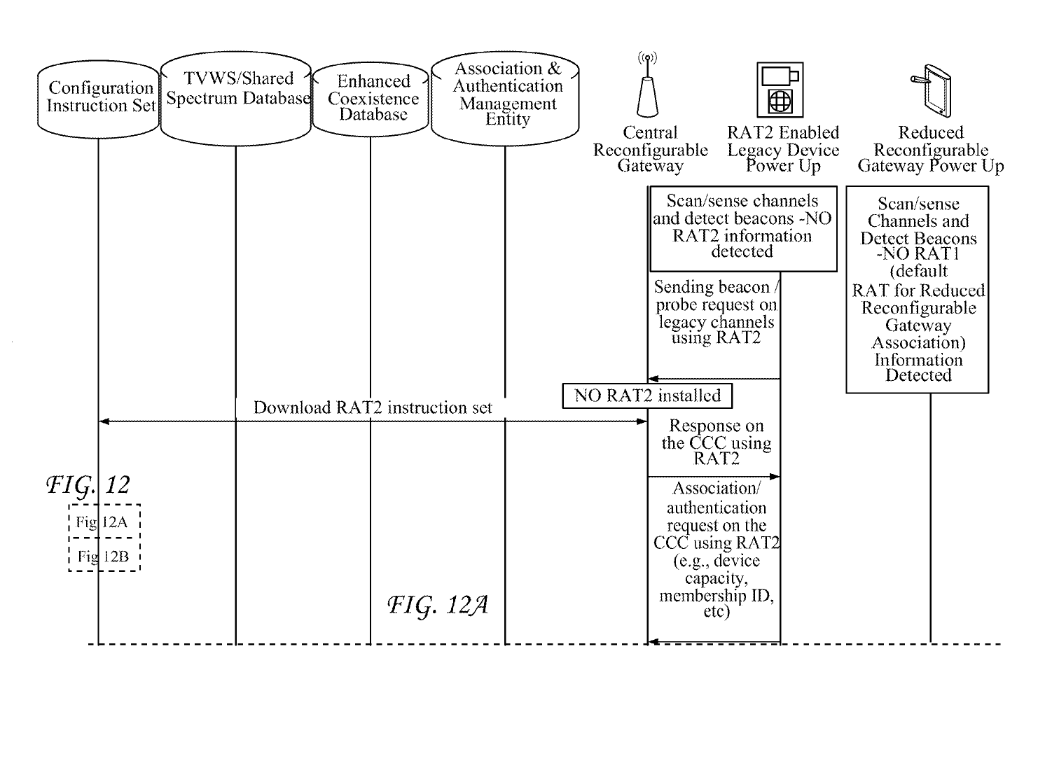

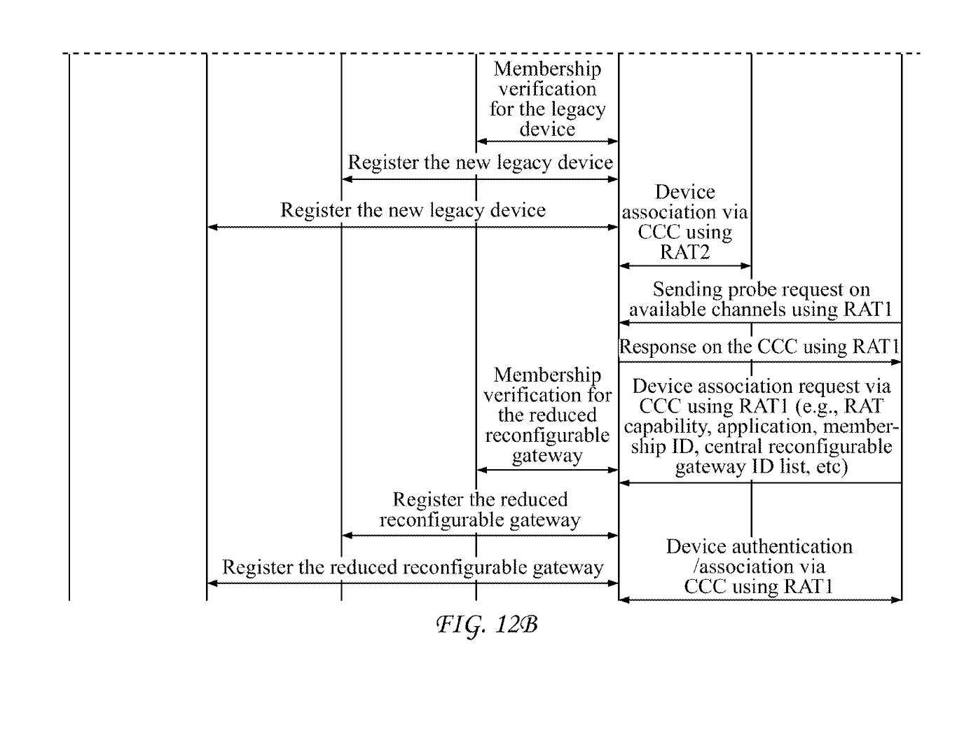

Turning to FIG. 12, neighboring devices may use active scanning methods to sense channels and detect beacons in different ways. For one example of active scanning, a RAT2-enabled legacy device may power up, scan the channel and find no RAT2-enabled beacon detected. The device may send a beacon/probe request on the available channel using RAT2. The CRG may receive the request. If RAT2 is not pre-installed in the CRG, the CRG may download the RAT2 from an available configuration instruction set. After the installation of RAT2 instruction set, the CRG may send a response to the request on the CCC using RAT2.

A legacy device receives the response and may send the association and authentication request to the CRG, which may include RAT capability, application, membership ID, etc. The CRG may perform membership verification for the legacy device with the authentication and association entity in the public/private IP network. When membership is confirmed, the CRG may register the legacy device with the enhanced coexistence database entity in the public/private IP network. The CRG may register the new legacy device with the TVWS/Shared Spectrum database entity in the public/private IP network. As may be appreciated, devices capable of operating on TVWS/Shared Spectrum may be registered with TVWS/Shared Spectrum and Enhanced Coexistence Database. A device authentication and association signaling may take place between the CRG and the legacy device via the CCC using RAT2.

For example, during an active scanning, a reduced reconfigurable gateway (RRG) may power up, scan the channels, and find no RAT1 enabled beacon (which may be the default RAT for RRGs) detected. The RRG may send a probe request on the available channel using RAT1. The CRG may receive the request and send the response on the CCC using RAT1. The RRG may send the association and authentication request to the CRG, which may include RAT capability, application, membership ID, etc. The CRG may perform membership verification for the RRG with the authentication and association entity in the public/private IP network. When membership is confirmed, the CRG may register the RRG with the enhanced coexistence database entity in the public/private IP network. The CRG may register the RRG with the TVWS database entity in the public/private IP network. Thereafter, a device authentication and association signaling may take place between the CRG and the RRG via the CCC using RAT1.

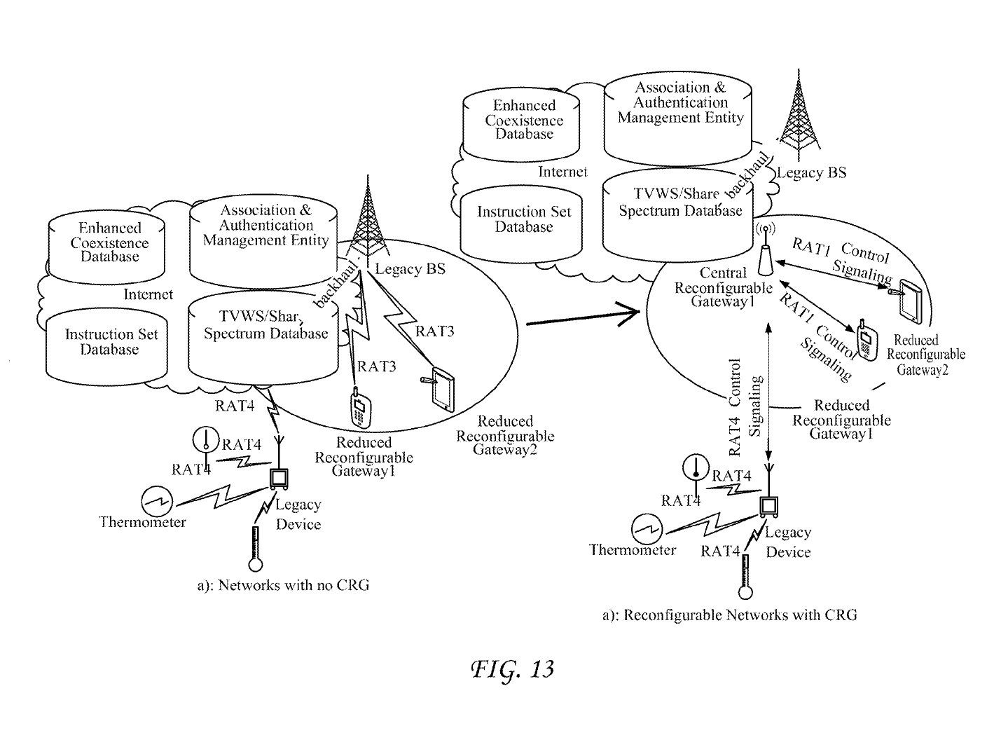

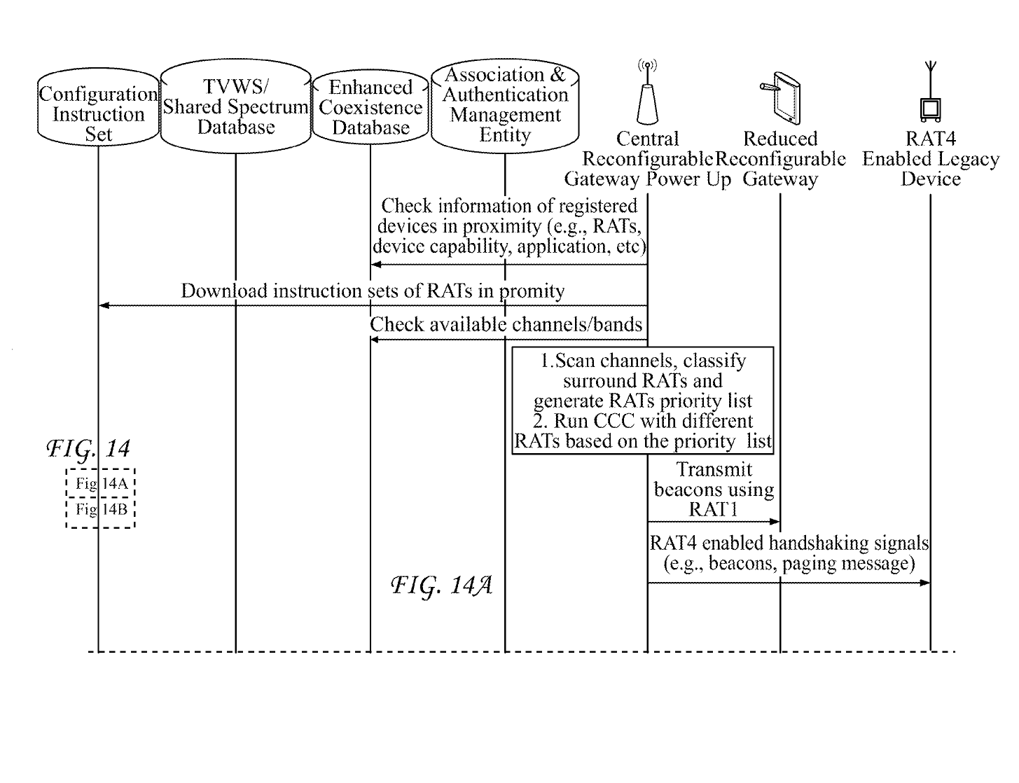

Turning to FIG. 13, in a scenario where no CRG exists initially (left portion of FIG. 13), the devices in the network may be either connected to a traditional central controller such as a legacy base station (BS) or may be directly connected to the internet. A CRG may power up, discover the neighbors and form the reconfigurable network as shown (right portion of FIG. 13). The CRG may handshake with RRGs on the CCC using a default RAT, e.g., RAT1 and with legacy devices using legacy protocols transmitted on the CCC.

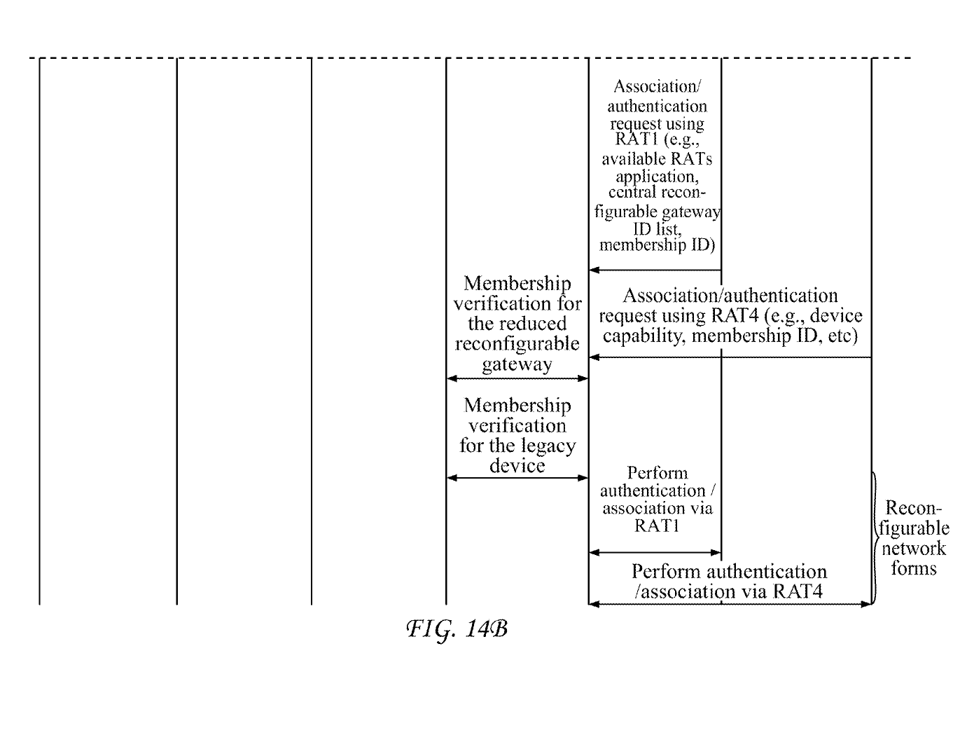

FIG. 14 shows an example of a call flow for reconfigurable network formation for connected devices. When the CRG powers up initially, such CRG may check information of registered devices in proximity (e.g., RATs, device capability, application, etc.) with an enhanced coexistence database. The CRG may check available channels/bands with a TVWS/Shared Spectrum database. The CRG may scan channels, classify surrounding RATs, and generate a RATs priority list, and run the CCC with different RATs based on the generated priority list. The CRG may transmit beacons to the RRG using RAT1. The RRG may send association/authentication request using RAT1 (e.g., available RATs, application, CRG ID list, membership ID). The CRG may perform membership verification for the RRG with an association and authentication management entity, and perform authentication/association over the air with the RRG.

Similarly, the CRG may use RAT4 to transmit handshaking signals (e.g., beacons, paging message, etc.) to a RAT4-enabled legacy device. The RAT4-enabled legacy device may send an association/authentication request using RAT4 (e.g., device capability, membership ID, etc.). The CRG may perform membership verification for the legacy device with the association and authentication management entity, and perform authentication/association over the air with the legacy device. When the CRG performs authentication/association over the air with legacy devices and the RRGs, the reconfigurable formation is complete.

The CCC may be maintained with a relatively low data rate to provide relatively large coverage. The CCC may be used transmit the data. The CCC may assist in establishing and maintaining data link communications including initial data link set-up and inter-RAT switching.

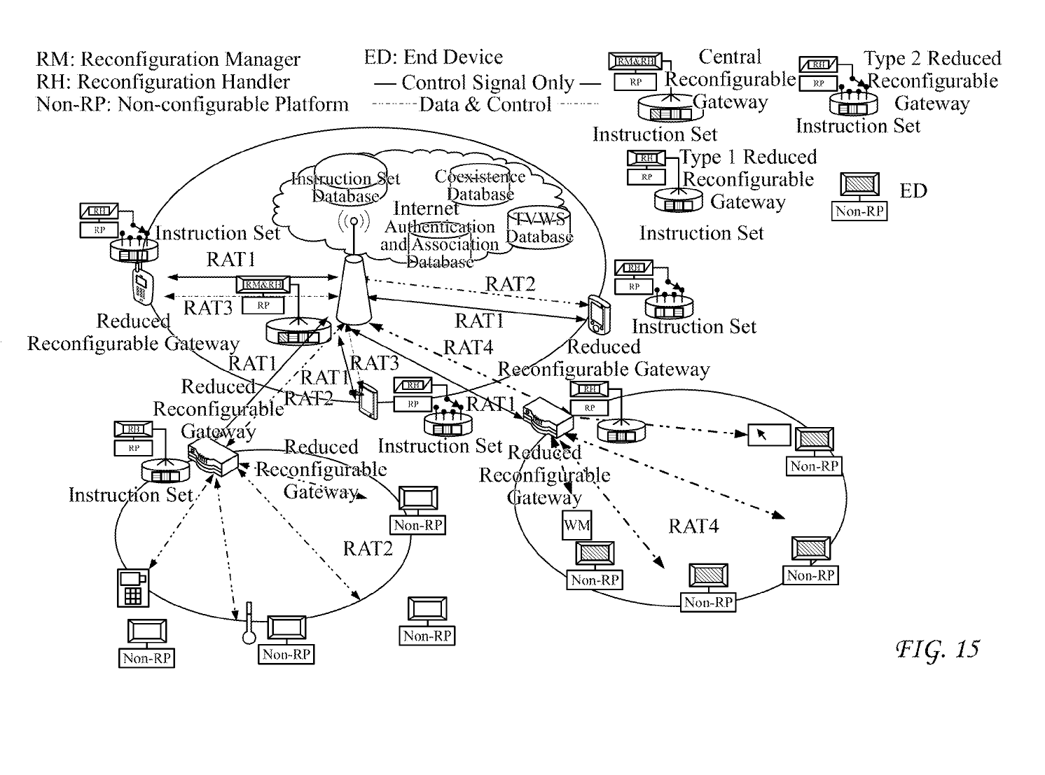

Turning to FIG. 15, a reconfigurable wireless network deployment scenario with control signaling and data transmission is shown. A multi-layered wireless network may include a CRG, an RRG and a Legacy device. The CRG may interface with the instruction set database, coexistence database, authentication and association database and TVWS database located in the public/private IP network. The CRG may directly or indirectly interface with the RRGs. The solid arrows depict the common control channel. The CCC may use a single RAT. The dashed arrows depict the data and control channels. The data and control may use one or more RATs.

Each RRG may be the controller node for a set of legacy devices with non-configurable platforms, and the RRG communicates with same using a single RAT. The CCC participates in control signaling.

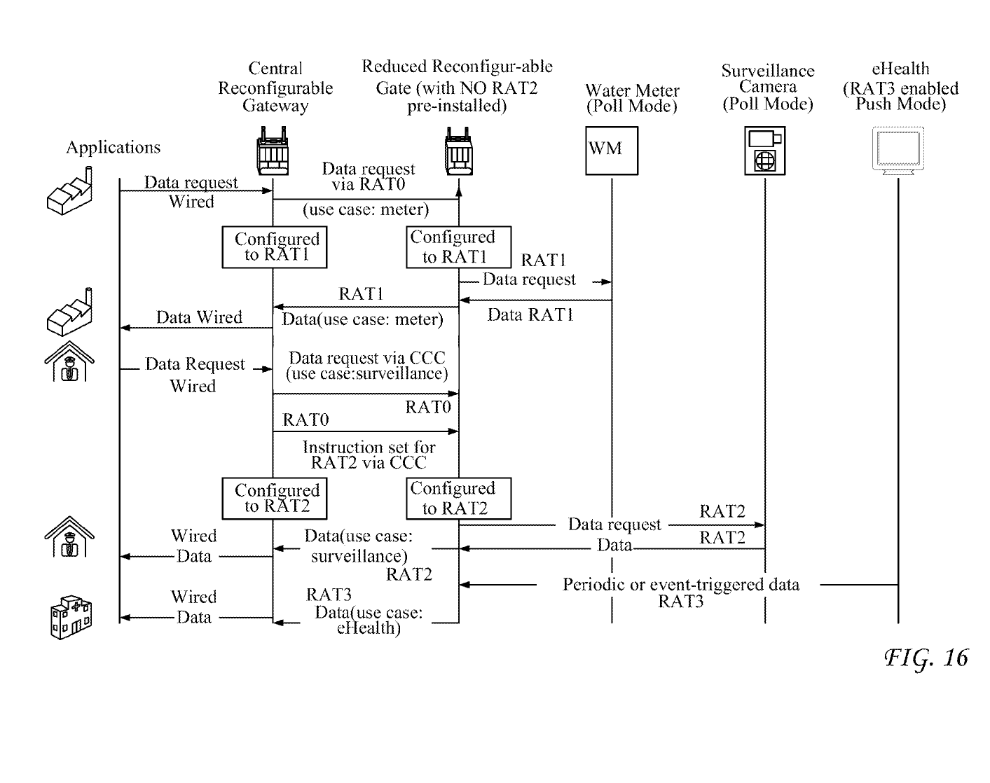

Turning now to FIG. 16, a data communication procedure enables communications between a CRG and legacy devices by way of a RRG, which transmits instruction sets via the CCC. Presumptively, each legacy device can operate in a poll mode, which enables data transmission upon the receipt of request from the CRG/RRG; and/or in a push mode, which enables data transmission to the CRG/RRG in a periodic fashion without any request or self-event trigger.

For example, the CRG may receive a request from a water utility company for data. The CRG may send a data request to the RRG (via RAT0) for meter data from a water meter device. The data request may be forwarded from the RRG to the water meter, which may be a RAT1 enabled legacy device operating in poll mode. To accommodate the communication with the water meter as well as meet the QoS requirement of the data transmission from the water meter, both the CRG and the RRG may be configured to use RAT1. The water meter may use RAT1 to send the data to the RRG upon the receipt of the data request. Thereafter, the RRG may forward the data from the water meter to the CRG using RAT1, and the CRG may send the data back to the water utility.

In another example, the CRG may obtain a request for data from a police department. The CRG sends the request to the RRG via the CCC (using RAT0). The request may be intended to be delivered to a surveillance camera, which may be a RAT2 enabled legacy device operating in poll mode. When the RRG does not have RAT2 installed, the CRG may send the instruction set for RAT2 to the RRG through the CCC. RRG may configure itself to RAT2 based on the received instruction set, forward the data request to the surveillance camera using RAT2, receive from the surveillance camera the data using RAT2, and forward the data to the CRG with RAT2 for further forwarding to the requesting police department.

In another example, the eHealth system, which may be a health monitoring device, may be a RAT3-enabled legacy device operating in push mode. Without any external request, the eHealth system may periodically deliver data to the RRG which forwards same via the CRG to a final destination such as for example a hospital or a health monitoring service.

A CRG centralizes electronic communications within a site such as a home, an office, a factory, a stadium, a park, or any other indoor or outdoor area, by employing a central gateway that may be coupled to an external communications network. The CRG configures an internal communications network, and recognizes each device within the internal communications network even if the devices are disparate and use different RATs. Accordingly, the devices can communicate with the external communications network by way of (e.g., exclusively by way of) the central gateway.

A disparate device need not have its own separate base station and separate connection to the external communications network. The CRG may function as the common base station for the disparate devices, and can efficiently arrange for the devices to communicate within the site. Moreover, the CRG may be dynamic in that it can discover new devices as they may be introduced into the network, by obtaining protocols for each new device from a local database, and/or from a remote database if not available at the local database. The CRG may effectuate a wired and/or wireless telephone line for the site, wired and/or wireless data communications for the site, a wired and/or wireless alarm system for the site, a wired and/or wireless health monitoring system for the site, a wired and/or wireless appliance monitoring system for the site, a wired and/or wireless surveillance system for the site, wired and/or wireless multimedia content systems within the site, and the like.

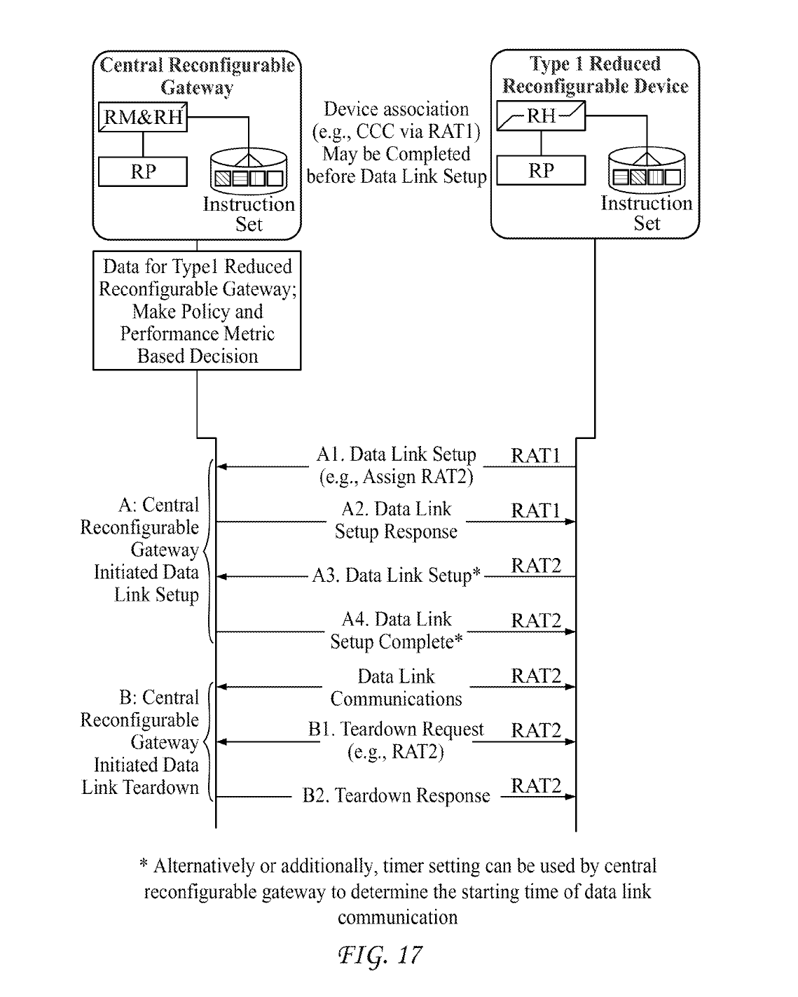

Turning now to FIG. 17, a call flow for a CRG-initiated initial link setup and teardown to a Type I RRG is shown. Device association (e.g., CCC via RAT1) may be completed before data link setup. When the CRG receives data for an RRG, the CRG may make policy and performance metric based decisions (e.g., an appropriate channel/band and RAT used in data communication). The CRG may initiate a data link setup with the RRG. The CRG may send a data link setup signal to the RRG to which the RRG responds with a data link setup response complete signal using RAT2. This may be followed by a RAT2-enabled data transfer between the CRG and RRG. At the end of the data transfer session, the CRG may initiate a data link teardown. The CRG may send a teardown request signal to the RRG to which the RRG responds with a teardown response. A CRG-initiated link setup could be sent to one or multiple RRG devices simultaneously, for both download and upload communications. For the data communication between the CRG and the Type I RRG, the CCC and data communication may run in different RATs, which may provide more robust protection to the control signaling transmitted via CCC.

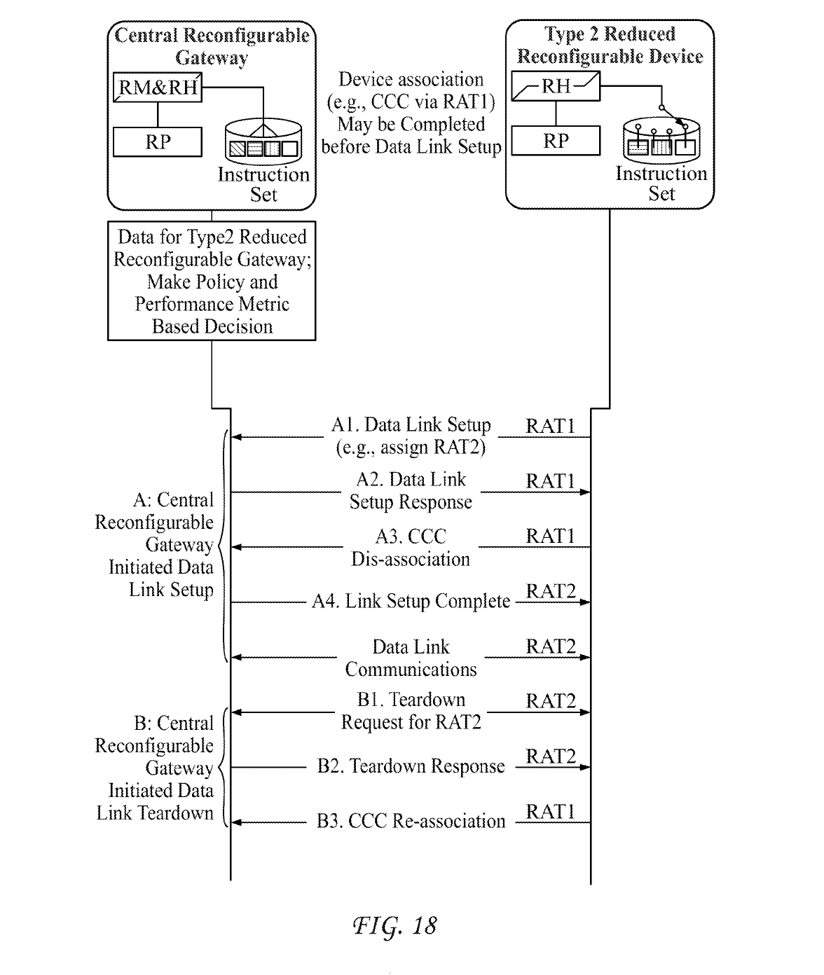

Turning now to FIG. 18, a call flow for a CRG-initiated initial link setup and teardown to a Type II RRG is shown. For example, device association may be completed before data link setup. When the CRG receives data for an RRG, the CRG again may make policy and performance metric based decisions and initiate a data link setup. The CRG may send a data link setup signal to the RRG to which the RRG may respond with a data link setup response complete signal. The CRG may send a CCC dissociation signal to the RRG and the RRG may respond with a dissociation complete signal. Data transfer between the CRG and RRG may follow, after which the CRG may initiate data link teardown. The CRG may send a teardown request signal to RRG to which the RRG may respond with a teardown response. At a later time, the CRG may send a CCC re-association signal to the RRG to setup a new connection. A CRG-initiated link setup could be sent to one or multiple RRG devices, for example, simultaneously, for both download and upload communications. CCC disassociation and re-association may be performed in the data link set up/tear-down between the CRG and the Type II RRG as a Type II RRG may support one RAT (e.g., only one) at one time. The control signaling can be transmitted with the data communication between the CRG and the Type II RRG (common RAT between data transmission and control signaling) after data link set-up is established.

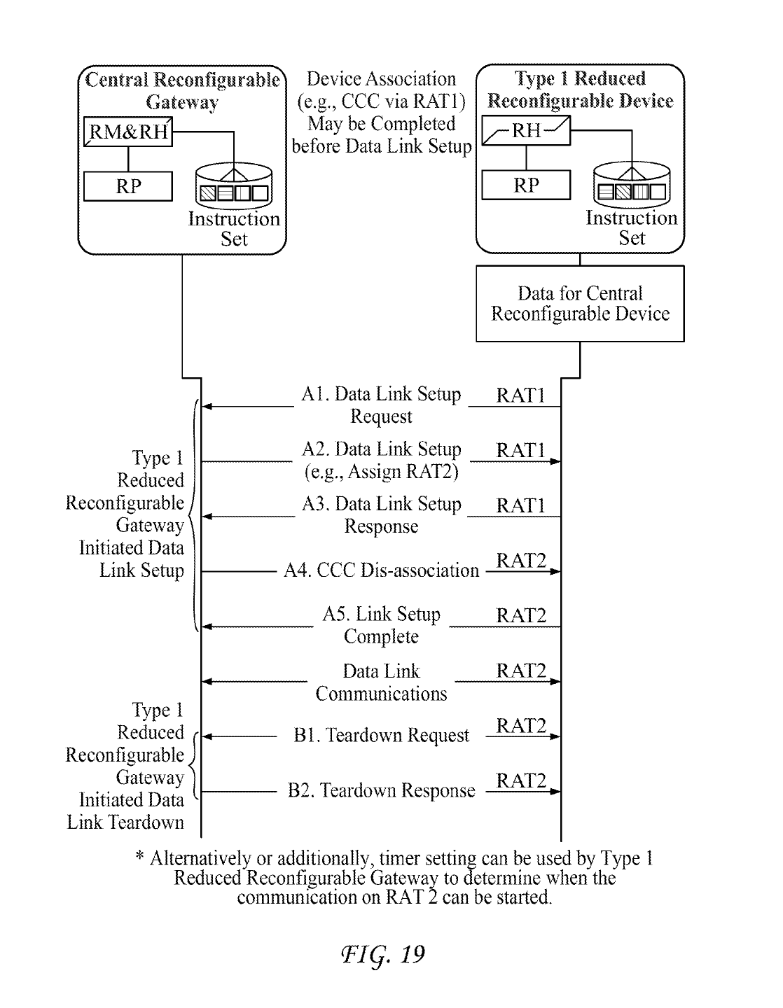

Turning now to FIG. 19, a call flow depicting a type I RRG-initiated initial link setup and teardown to the CRG is shown. For example, device association (e.g., CCC via RAT1) is completed before data link setup. When the RRG receives data for the CRG, the RRG may initiate a data link setup request with the CRG as shown by the ‘A’ set of signals. The RRG may send a data link setup signal to the CRG to which the CRG may respond with a data link setup response signal. Data may be transferred between the CRG and RRG. After the end of the data transfer session, the RRG may initiate a data link teardown. The RRG may send a teardown request signal to CRG to which the CRG may respond with a teardown response.

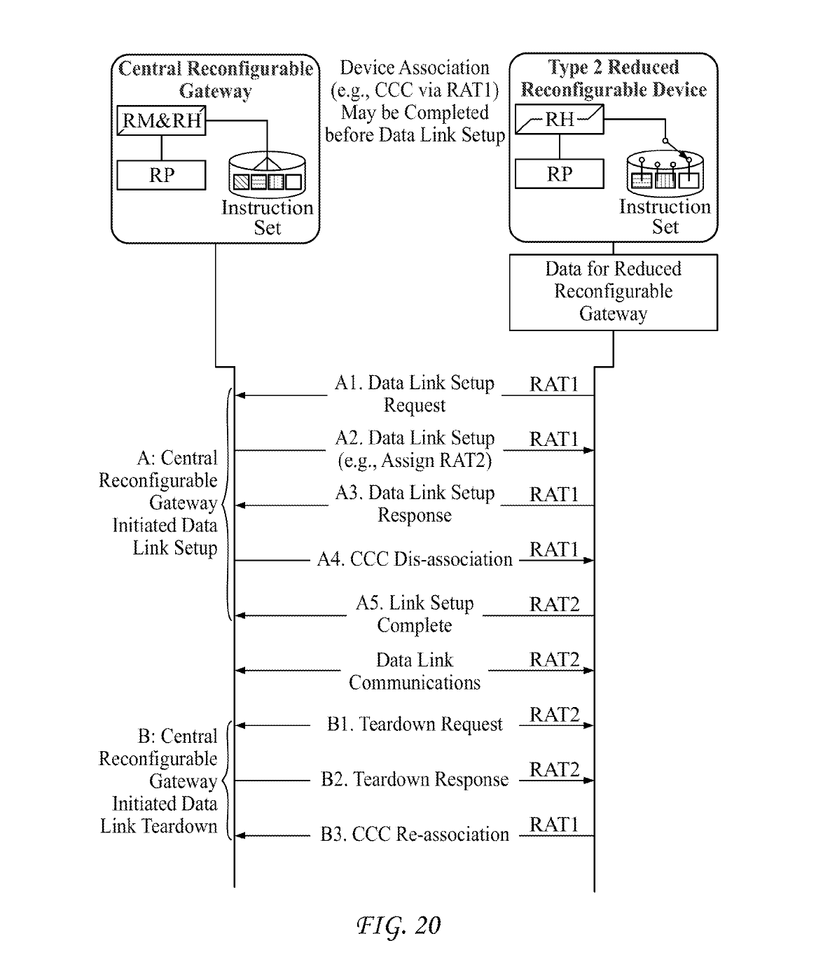

Turning now to FIG. 20, a call flow depicting a type II RRG-initiated initial link setup and teardown to the CRG is shown. For example, device association (e.g., CCC via RAT1) is completed before data link setup. When the RRG receives data for the CRG, the RRG may initiate a data link setup request with the CRG as is shown by the ‘A’ set of signals. The RRG may send a data link setup signal to the CRG to which the CRG may respond with a data link setup response signal. The CRG may send a CCC dissociation signal to the RRG and the RRG may respond with a link setup complete signal. Data may be transferred between the CRG and RRG. At the end of the data transfer session, the RRG may initiate a data link teardown as is shown by the ‘B’ set of signals. The RRG may send a teardown request signal to the CRG to which the CRG may respond with a teardown response. Later, the CRG may send a CCC re-association signal to the RRG to set up a new connection.

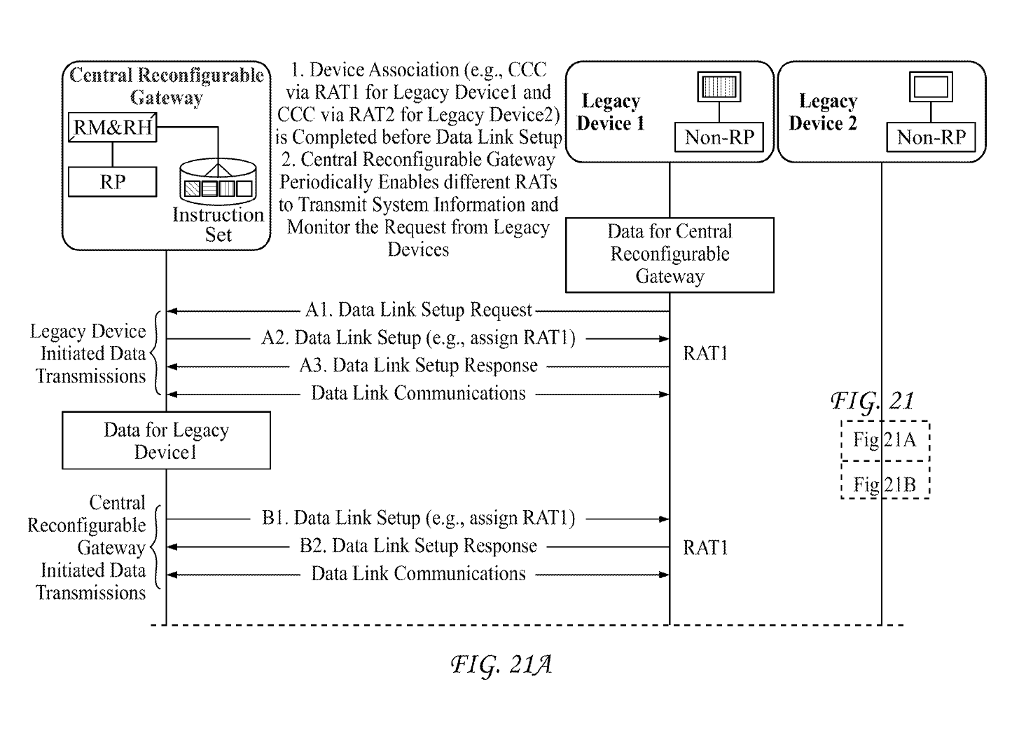

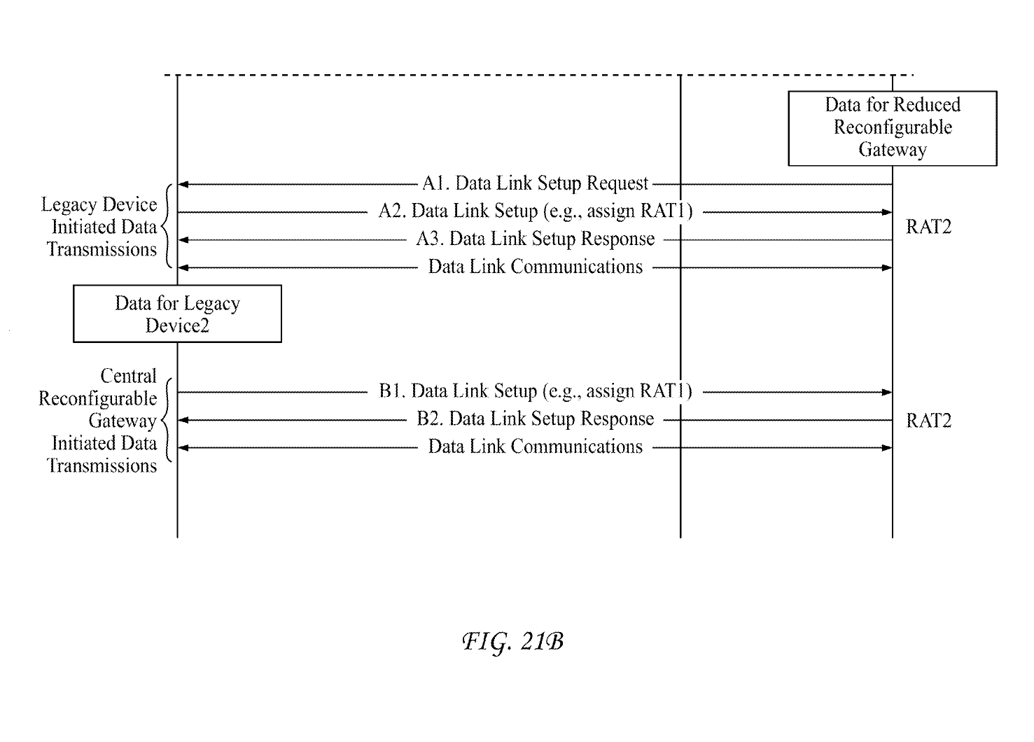

Turning now to FIG. 21, a call flow shows data transmissions between the CRG and legacy devices. For example, device association (e.g., CCC via RAT1) may be completed before data link setup, and the CRG may periodically enable different RATs to transmit system information and monitor requests from the legacy device. When the legacy device has data to transmit to the CRG, such device may initiate a data link setup request signal. The CRG may respond with a data link setup signal and the legacy device may send a data link setup response signal. Data link communications may follow. When the CRG has data to send to the legacy device, the CRG may initiate a data link setup signal to which the legacy device may respond with a data link setup response signal. Data link communications may follow.

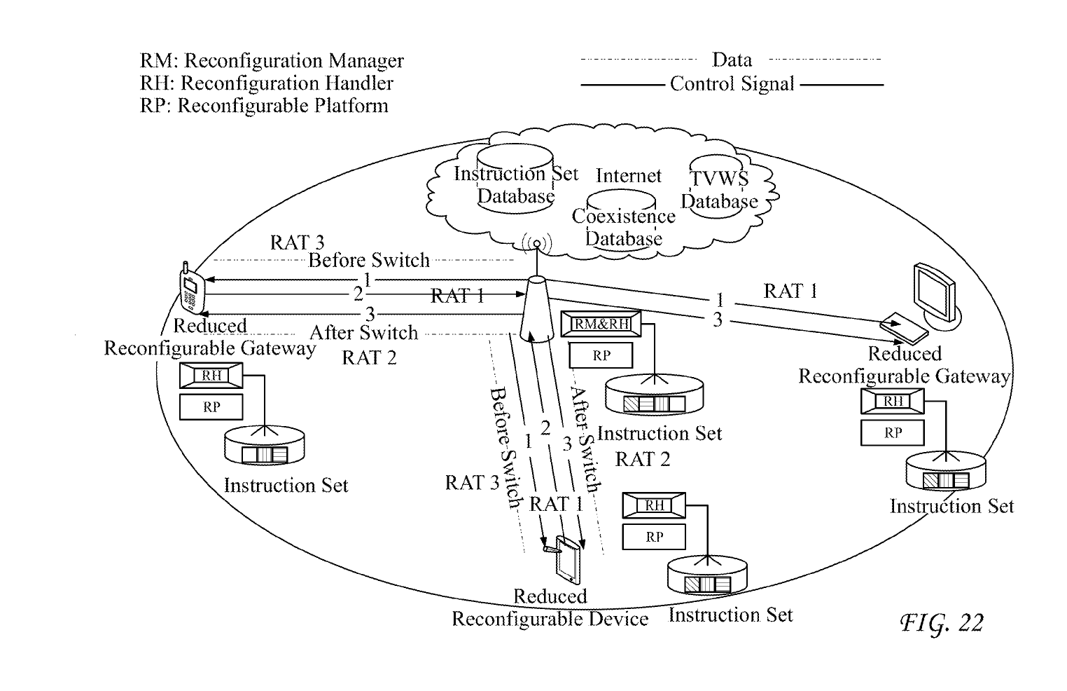

Turning now to FIG. 22, the CRG may guide an associated Type I RRG to switch RATs. Reconfigurable devices can switch RATs based on different criteria, e.g., QoS requirement, channel conditions, etc. Some of the bases and/or criteria for a RAT switch could be QoS provisioning, history of Inter-RAT switching, channel conditions, frequency availability, device capability, switching delay, traffic load, etc. For example, when a channel is busy and co-existing with many other networks, using CSMA-CA may be simple and friendly to other networks. When a channel is used by a single network, using scheduler-based radio access (e.g., LTE) may be better as it avoids collision and provides better interference management. The CRG may broadcast (or multi-cast) the Inter-RAT Switch Request message via the CCC. The CCC-connected RRGs may transmit the Inter-RAT Switch Response message via the CCC. The CRG may collect response messages from the RRGs and broadcast (or multi-cast) the Inter-RAT Switch message to start using the new RAT.

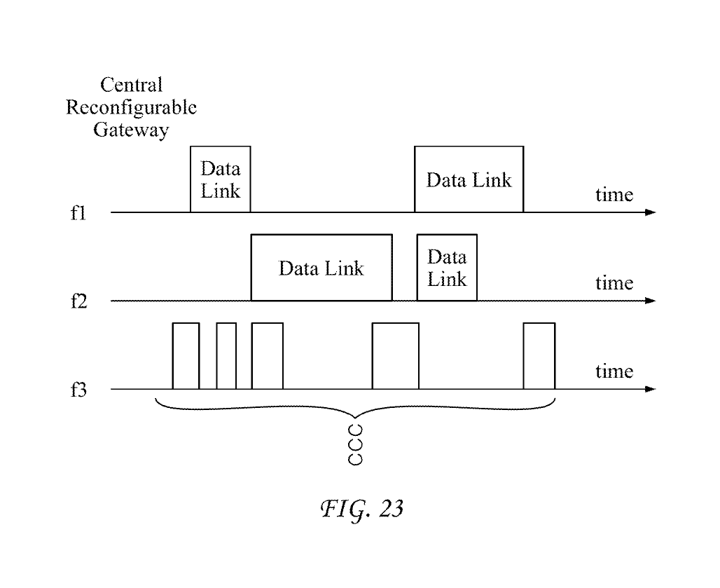

Turning now to FIG. 23, a data link and the CCC can be multiplexed on multiple frequencies. In particular, since both the CRG and a Type I RRG can support multiple reconfigurable platforms, multiple RATs can run simultaneously on different frequencies. For CCC and data link multiplexing, fixed separate RATs may be employed for data link and CCC. In this example, the CCC operates on f3, and the data link on f1 and f2.

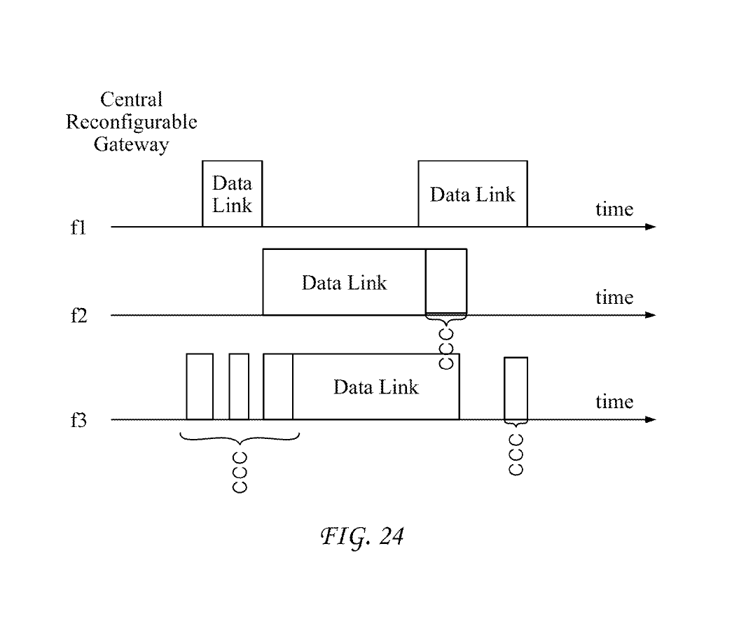

Turning now to FIG. 24, a data link and the CCC can be multiplexed on multiple frequencies. In particular, since both the CRG and a Type I RRG can support multiple reconfigurable platforms, multiple RATs can run simultaneously on different frequencies. For CCC and data link multiplexing, common RATs may be employed for data link and CCC, for example each of f2 and f3 share part of the CCC.

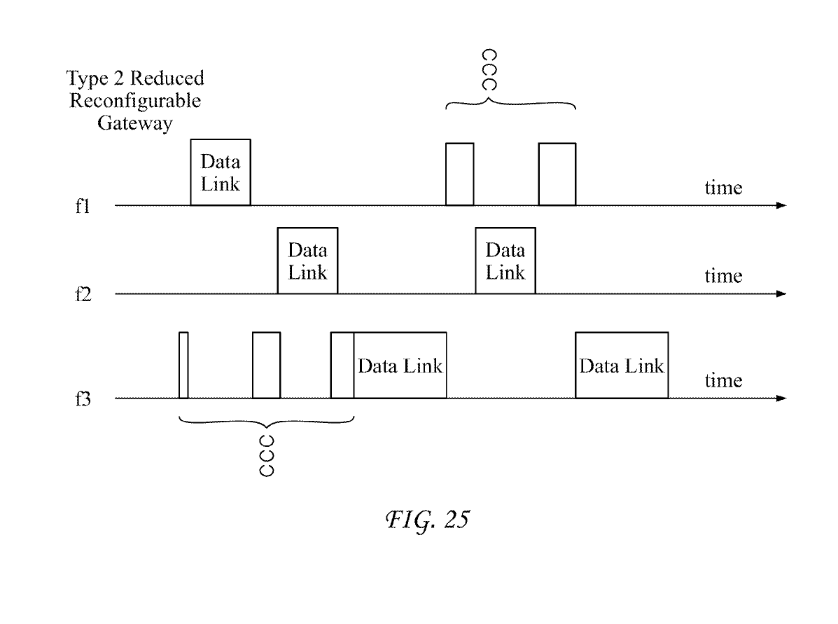

Turning now to FIG. 25, a Type II RRG may support one RAT at one time. A data link and the CCC can be multiplexed on multiple frequencies if switching. For data link and CCC running on multiple frequencies with multiple RATs, different RATs may be employed for different frequencies, as is shown in FIG. 25 (here, the frequencies/RAT used for the CCC and data links can be changeable but the RAT supportable by one frequency band may be fixed).

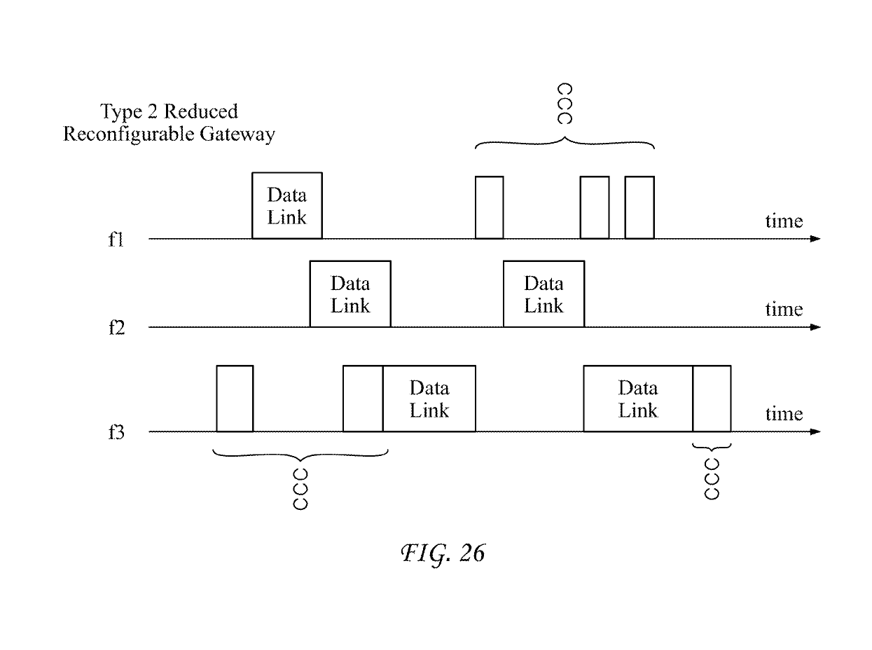

Turning now to FIG. 26, the same RATs may be employed on different frequencies. The same RAT can be run on different frequencies for different usages. For example, one RAT can be run in both f1 and f2, the former for data link communication and the latter the CCC, and the frequencies/RATs used for the CCC and data links may be changeable.

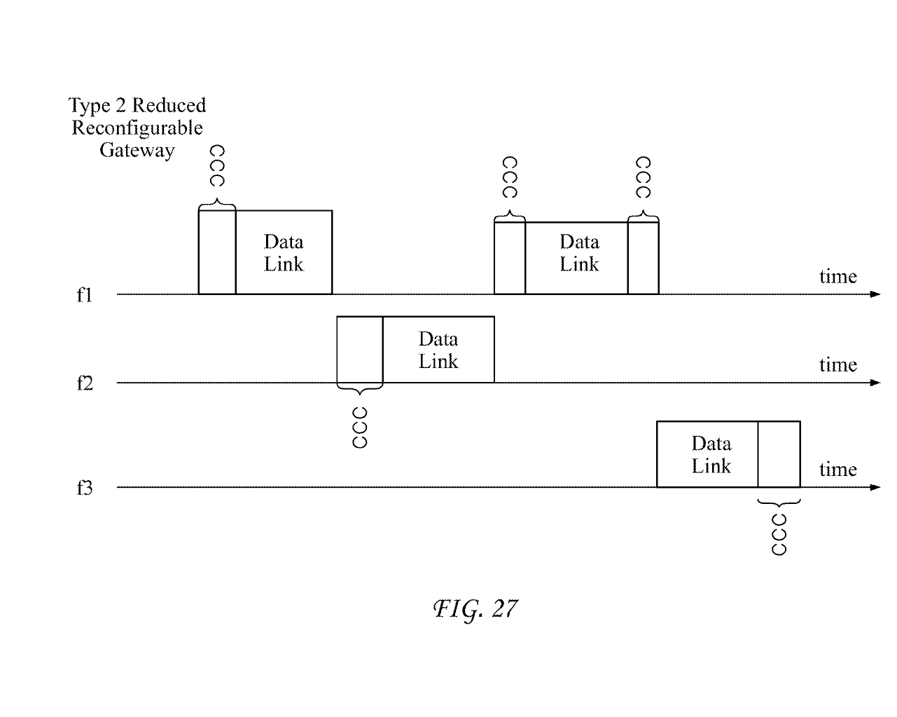

Turning now to FIG. 27, different RATs may be employed on the same frequency, multiple RATs can be supportable by one frequency. For example, CCC and data link communication may use different RATs but always occur in the same frequency, and their operational frequency can be switched to any available one(s)).

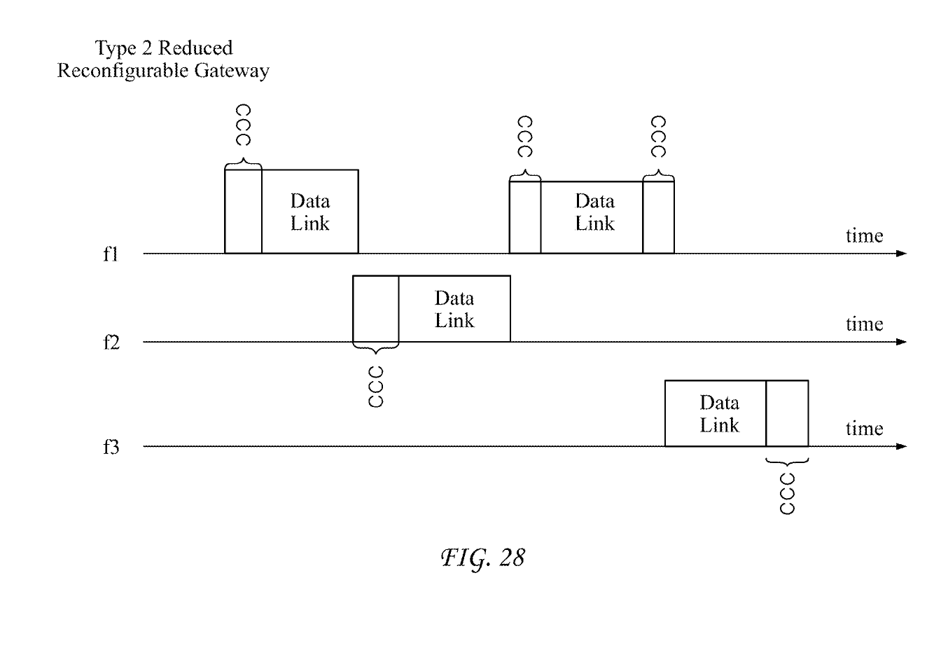

Turning now to FIG. 28, the same RAT may be employed on the same frequency band. For example, the CCC and data link shares the common RAT and frequency, although the RAT and frequency can be dynamically changed over time.

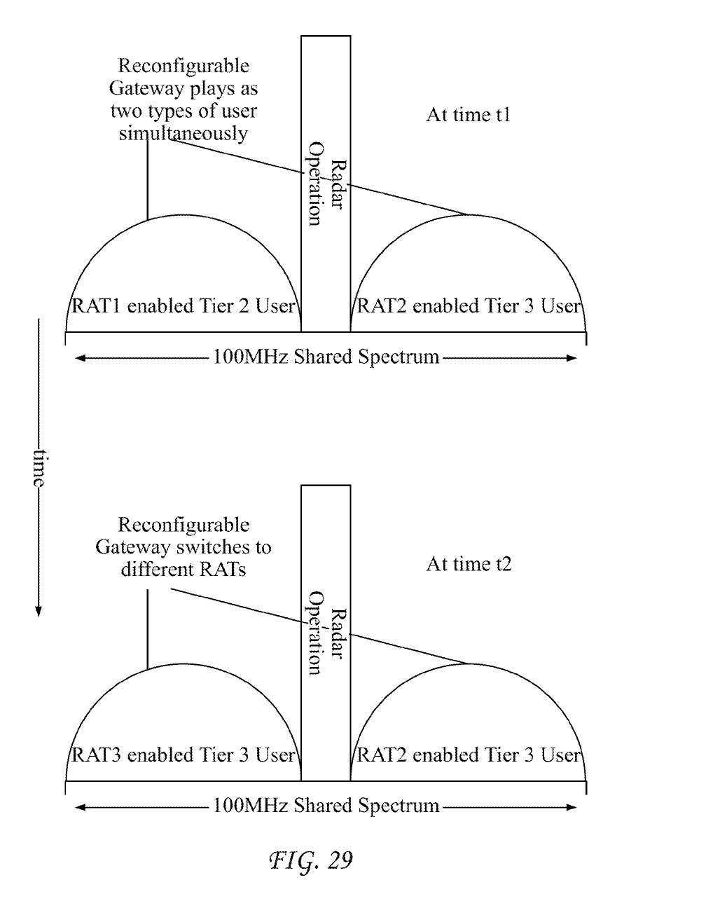

Turning now to FIG. 29, in a shared spectrum, a multi-tier hierarchical architecture may be applied. Due to the unique characteristics of the tier-2 and tier-3 access users, different RATs used by different tier communications may be supported by the same reconfigurable gateways in different spectrum. Within the same spectrum, different RATs may be employed in different periods of time. A reconfigurable device/gateway may be a good candidate for shared-spectrum communication. A CRG may schedule and configure associated devices to different RATs and switch between tier 2 and tier 3 access opportunistically based on different criteria, e.g., device capability, traffic load, QoS requirements, etc. A RRG may communicate tier 2 or tier 3 users with different RATs according to the availability of spectrum, usage preference, QoS requirements, etc. For example, a reconfigurable network could provide more flexible communication.

1. A central entity for connecting a wireless transmit receive unit (WRTU) to an external network, comprising:
a processor, configured to:
send discovery signals via a plurality of Radio Access Technology (RAT) frequencies to discover the WTRU,
detect a RAT associated with the WTRU, provided that if the central entity is missing the RAT, the central entity is configured to download and install an instruction set corresponding to the RAT, and
establish a data link with the WTRU.

2. The central entity of claim 1, wherein the central entity is configured to send control information on a common control channel via different RATs at different times.

3. The central entity of claim 1, wherein the central entity is configured to discover the WTRU by receiving a beacon request that the WTRU transmits.

4. The central entity of claim 1, wherein the central entity is configured to simultaneously discover multiple WTRUs.

5. The central entity of claim 1, wherein the central entity is configured to receive an association and authentication request from the WTRU.

6. The central entity of claim 1, wherein the central entity is configured to send a teardown request signal to the WTRU after data transfer.

7. The central entity of claim 1, wherein the central entity is configured to prevent the Reduced Reconfigurable Gateway (RRG) from directly accessing the external network.

8. The central entity of claim 1, wherein the central entity is configured to use a first RAT to discover the WTRU, and a second RAT (different from the first RAT) to establish the data link.

9. The central entity of claim 8, wherein the central entity is configured to send a disassociation signal to the WTRU for the first RAT.

10. The central entity of claim 9, wherein the central entity is configured to send a re-association signal to the WTRU for the first RAT.

11. A method of using a central entity for connecting a wireless transmit receive unit (WRTU) to an external network, comprising:
sending discovery signals from the central entity via a plurality of Radio Access Technology (RAT) frequencies to discover the WTRU,
detecting a RAT associated with the WTRU, provided that if the central entity is missing the RAT, the central entity is configured to download and install an instruction set corresponding to the RAT, and
establishing a data link with the WTRU.

12. The method of claim 11, further comprising sending control information on a common control channel via different RATs at different times.

13. The method of claim 11, further comprising actively discovering the WTRU.

14. The method of claim 11, further comprising passively discovering the WTRU.

15. The method of claim 11, further comprising receiving an association and authentication request from the WTRU.

16. The method of claim 11, further comprising sending a teardown request signal to the WTRU after data transfer.

17. The method of claim 11, further comprising varying both RATs and operational frequencies during data link communication.

18. The method of claim 11, further comprising using a first RAT to discover the WTRU, and using a second RAT (different from the first RAT) to establish the data link.

19. The method of claim 18, further comprising sending a disassociation signal to the WTRU for the first RAT.

20. The method of claim 19, further comprising sending a re-association signal to the WTRU for the first RAT.
